(19) United States
(12) Patent Application Publication
(10) Pub. No.: US 2016/0034642 A1
(43) Pub. Date: Feb. 4, 2016

(54) PATIENT IDENTIFICATION USING UNIVERSAL HEALTH IDENTIFIER

(71) Applicant: Welch Allyn, Inc., Skaneateles Falls, NY (US)

(72) Inventors: Michael A. Ehrhart, Liverpool, NY (US); Ynjiun Paul Wang, Cupertino, CA (US)

(21) Appl. No.: 14/447,198

(22) Filed: Jul. 30, 2014

(51) Int. Cl. G06F 19/00

(52) U.S. Cl. CPC G06F 19/322

(57) ABSTRACT

A patient identification system utilizes a universal health identifier. The universal health identifier is an identification code that uniquely identifies the patient. Other identifiers associated with the patient can be linked to the universal health identifier, allowing the patient or a caregiver to use the other identifiers to obtain the universal health identifier. Health records can be associated with the universal health identifier to promote access to the health records.

### BACKGROUND

Each time a patient visits a doctor or other caregiver for medical care, a record of the encounter is generated and saved. These records document a variety of encounters, such as hospital visits, routine checkups, lab tests, and many other types of encounters. Additionally, medical instruments and medical devices also commonly generate data that is saved as further records. Although some efforts are being made to centralize or link records from various sources, most health care information is currently maintained by the respective health care providers. As a result, it is difficult for a patient or caregiver to access and review these records.

### SUMMARY

In general terms, this disclosure is directed to patient identification using a universal health identifier. In one possible configuration and by non-limiting example, the universal health identifier is an identification code that uniquely identifies the patient. Other identifiers associated with the patient can be linked to the universal health identifier, allowing the patient or the caregiver to use the other identifiers to obtain the universal health identifier. Various aspects are described in this disclosure, which include, but are not limited to, the following aspects.

One aspect is a method for registering and issuing a universal health identifier associated with a patient over a communication network, the method comprising: receiving with a computing device a patient identifier associated with a patient; generating a patient hashing identifier using the patient identifier; generating a universal health identifier; and associating the universal health identifier to the patient identifier.

Another aspect is a method of distributing a universal health identifier across a data communication network, the method comprising: receiving a request using a computing device, the request including a patient hashing identifier, the patient hashing identifier being a code generated by applying a hashing function to a patient identifier; retrieving a universal health identifier associated to the patient hashing identifier; and sending a response to the request, the response including the universal health identifier.

A further aspect is a method of providing access to medical records, the method comprising: receiving, using a computing device, a universal health identifier associated with a patient from a data communication network; using the universal health identifier to retrieve a link to a medical record associated with the patient from a repository; and sending the link to the medical record through the data communication network.

Another aspect is a method for registering and issuing a universal health identifier associated with a patient over a communication network, the method comprising: receiving with a computing device a patient demographics record; attempting to match the patient demographics record with existing patient records, and when a match is not found: generating a patient hashing identifier using the patient identifier; generating a universal health identifier; and associating the universal health identifier to the patient identifier.

Yet another aspect is a method of distributing a universal health identifier across a data communication network, the method comprising: receiving a request using a computing device, the request including a patient demographics record; matching with existing patient records and when a match is found: retrieving a universal health identifier associated to the patient demographics record; and sending a response to the request, the response including the universal health identifier.

A further aspect is a method of providing access to medical records, the method comprising: receiving, using a computing device, a patient demographics record associated with a patient from a data communication network; using a universal health identifier associated to the patient demographics record to retrieve a link to a medical record associated with the patient from a repository; and sending the link to the medical record through the data communication network.

### BRIEF DESCRIPTION OF THE DRAWINGS

FIG. 1 is a schematic diagram illustrating an example patient identification system.

FIG. 2 illustrates an exemplary architecture of a computing device that can be used to implement aspects of the present disclosure.

FIG. 3 is a schematic block diagram illustrating an example of the universal health identifier server.

FIG. 4 is a flow chart illustrating an example method of operating the universal health identifier server shown in FIG. 3.

FIG. 5 is a flow chart illustrating an example method of registering a patient with the universal health identifier server shown in FIG. 3.

FIG. 6 is a screen shot of an example user interface generated by a registration engine of the example universal health identifier server shown in FIG. 3.

FIG. 7 is a screen shot of an example registration user interface generated by a registration engine of the example universal health identifier server shown in FIG. 3.

FIG. 8 illustrates an example of an operation of the method shown in FIG. 5.

FIG. 9 is a screen shot of an example social network login user interface.

FIG. 10 is a screen shot of an example authorization user interface.

FIG. 11 is a schematic diagram illustrating a portion of the patient identification system, shown in FIG. 1.

FIG. 12 is a flow chart illustrating an example method of generating a universal health identifier for a patient.

FIG. 13 illustrates an example of an operation of the method shown in FIG. 12.

FIG. 14 is a schematic diagram illustrating an example of a patient record of the universal health identifier server shown in FIG. 1.

FIG. 15 is a screen shot of an example user interface generated by a patient identifier management engine of the example universal health identifier server shown in FIG. 3.

FIG. 16 is a screen shot of an example user interface, such as generated by the patient identifier management engine of FIG. 15, after selection of an add patient identifier control.

FIG. 17 is a screen shot of another example of the user interface shown in FIG. 15, further including a second patient identifier.

FIG. 18 is a schematic block diagram illustrating another example of a patient record after the addition of a second patient identifier.

FIG. 19 is a schematic block diagram illustrating another example of a portion of the universal health identifier server shown in FIG. 1.

FIG. 20 is a schematic block diagram illustrating another example of a portion of the universal health identifier server shown in FIG. 1.

FIG. 21 illustrates an example of a health record of the universal health identifier server shown in FIG. 1.

FIG. 22 is a schematic block diagram illustrating another example of a portion of the universal health identifier server shown in FIG. 1.

FIG. 23 illustrates an example of a search results response provided by the universal health identifier server shown in FIG. 1.

FIG. 24 is a schematic block diagram illustrating another example of a portion of a portion of the patient identification system shown in FIG. 1.

FIG. 25 is a screen shot of an example electronic health record system implementing aspects of the present disclosure.

FIG. 26 is a schematic block diagram illustrating an example of a cross-origin data presentation system.

FIG. 27 illustrates another example of a cross-origin data presentation system.

FIG. 28 is a schematic block diagram illustrating an example of the cross-origin data insertion engine.

FIG. 29 illustrates an example of a web page provided by a web page server prior to the addition of insertion data by the cross-origin data insertion engine.

FIG. 30 is a graphical representation of data stored by the cross-origin data provider, and available for display in a web page.

FIG. 31 is a screen shot of the example web page as displayed to the user computing device after the addition of insertion data to the web page from the cross-origin data provider.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

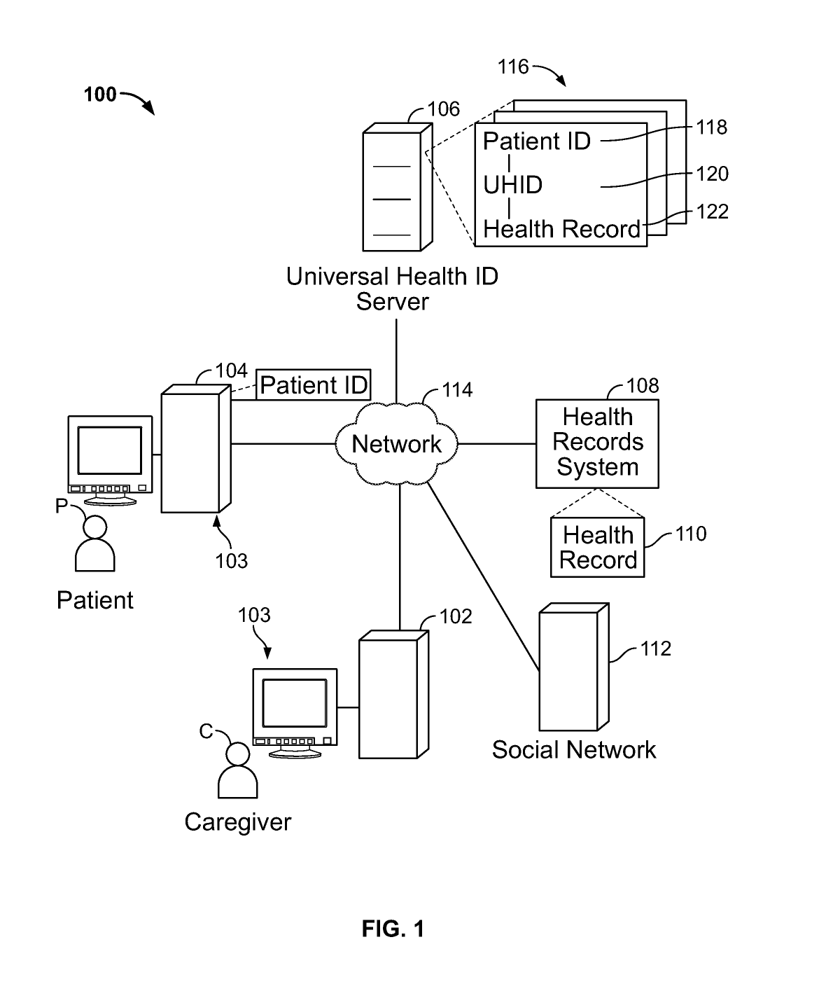

FIG. 1 is schematic diagram illustrating an example patient identification system 100. In this example, the patient identification system 100 includes one or more of: a caregiver computing device 102, a patient computing device 104, a universal health identifier server 106, a health records system 108 including health records 110, and a social network 112. The patient and caregiver computing devices 102 and 104 are examples of user computing devices 103. Additionally, the patient identification system 100 involves a patient P and a caregiver C. For the sake of simplicity, the example patient identification system 100 is illustrated and described as having only a single one of each of the described components, but it is recognized that in many implementations multiple of the components may also be present. For example, the system may include multiple of the described patients, caregivers, computing devices, servers, systems and social networks.

In some embodiments the patient identification system 100 is part of a healthcare system that operates to care for the health of the patient P. For example, a caregiver C obtains information that allows the caregiver C to better understand, diagnose, or treat health-related issues of the patient P.

In some embodiments, the patient identification system 100 generates and/or uses a universal health identifier that uniquely identifies the patient. The universal health identifier can be used in many different ways within the healthcare system. Several specific examples of such uses are described herein.

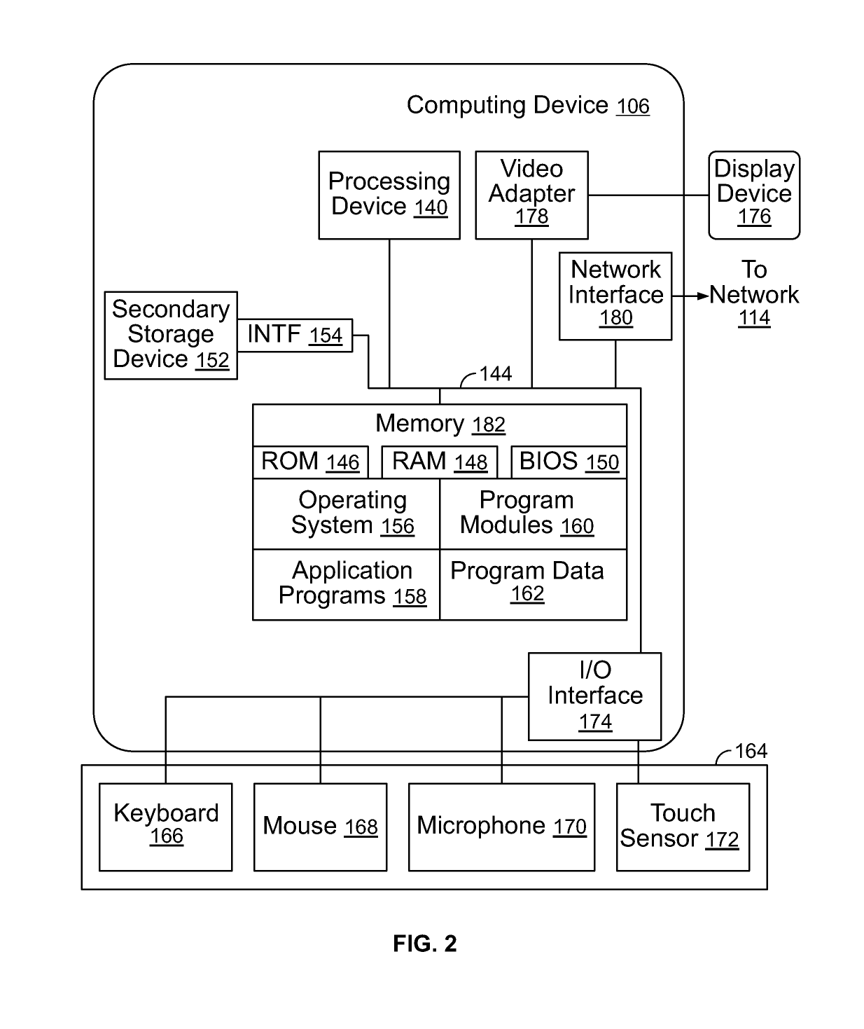

People, such as the caregiver C and the patient P, interact with the patient identification system 100 through one or more computing devices. For example, the caregiver C uses a computing device 102 to interact with the patient identification system 100, and the patient P uses a computing device 104 to interact with the patient identification system. An example of such computing devices 102 and 104 is illustrated and described in more detail with reference to FIG. 2. The computing devices 102 and 104 can include any device capable of processing data instructions, such as a desktop, laptop, or tablet computer, a smart phone, a wearable computing device, a medical instrument, a medical device, or other computing devices. The patient P and the caregiver C provide inputs through the computing devices 102 and 104 to interact with a user interface presented by the computing devices. The computing devices 102 and 104 are connected to one or more data communication networks 114, through which data can be transferred within the patient identification system 100 and the healthcare system.

The universal health identifier server 106 is a computing device that manages the universal health identifier and associations therewith. Although the universal health identifier server 106 is illustrated and primarily described as a single server, the functions of the server 106 can be distributed or replicated among multiple computing devices.

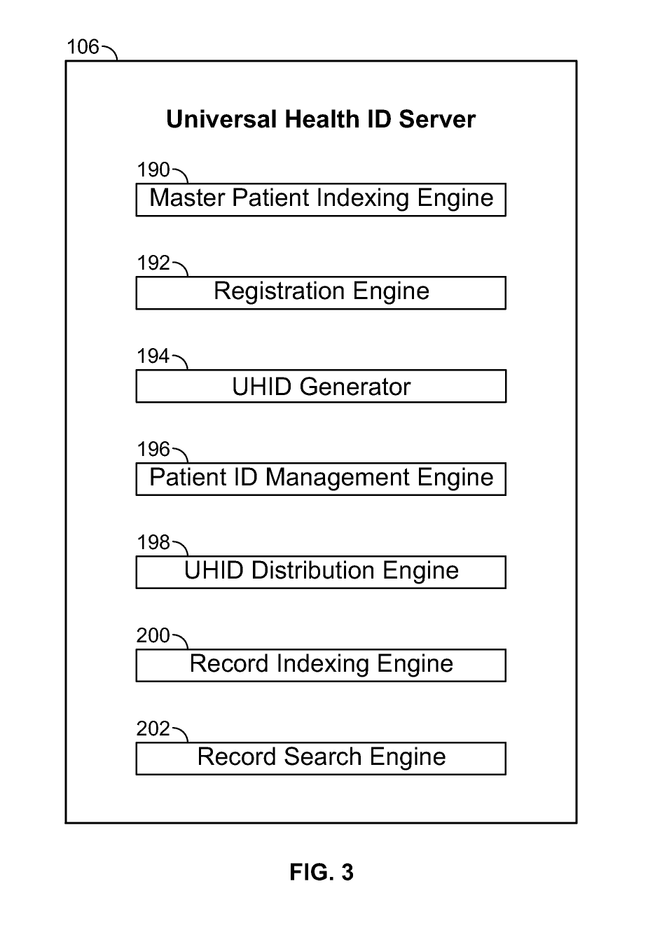

In some embodiments the universal health identifier server 106 generates a universal health identifier (UHID). The universal health identifier can also be associated with one or more patient identifiers, and/or with one or more health records of the patient. An example of the universal health identifier server 106 is illustrated and described in more detail with reference to FIG. 3.

In the illustrated example, the universal health identifier server 106 includes a database. In some embodiments the database includes one or more patient records 116. In this example the record includes a patient identifier 118, a universal health identifier 120, and a health record 122. This allows a health record 122 of the patient P to be identified using the universal health identifier 120, for example. The database is an example of a repository that can store patient records 116.

The health records system 108 includes one or more computing devices, such as server computing devices, that store at least one health record 110. In this example the health record 110 is a record that stores health-related information associated with the patient P. The health-related information can include a medical record generated by a caregiver C, or data from a medical instrument or medical device, for example. The health records system 108 can include an electronic medical records system, a medical device manufacturer's data records system, a caregiver medical records system, or other sources of health records 110.

Some embodiments involve or interact with a social network 112. For example, the social network can be used to validate an identity of the patient. In a basic form, the social network stores at least one patient identifier, such as the patient's name, e-mail address, telephone number, or other patient identifier. Further, in some embodiments the social network has at least one identification process for verifying the identity of a person, such as the patient P. One example of such an identification process is a username and password known by the patient P. Other identification processes can also be used in other embodiments. Several examples of social networks include the FACEBOOK, TWITTER, and GOOGLE CIRCLES social networks. Social networks can also include e-mail services, such as GMAIL, YAHOO MAIL, OUTLOOK, and other e-mail services. Other services or systems can also be used, provided that at least one patient identifier can be provided or verified by the service or system.

The network 114 includes one or more data communication networks, such as the Internet, a cellular communication network, a local area network, a wireless communication network, and the like.

FIG. 2 illustrates an exemplary architecture of a computing device that can be used to implement aspects of the present disclosure, including any of the caregiver computing device 102, the patient computing device 104, the universal health identifier server 106, a computing device of the health records system 108, a computing device of the social network 112, or other computing devices. The computing device illustrated in FIG. 2 can be used to execute the operating system, application programs, and software modules (including the software engines) described herein. By way of example, the computing device will be described below as the universal health identifier server computing device 106. To avoid undue repetition, this description of the computing device will not be separately repeated herein for each of the other computing devices, caregiver computing device 102, the patient computing device 104, a computing device of the health records system 108, a computing device of the social network 112, or other computing devices, but such devices can also be configured as illustrated and described with reference to FIG. 2.

The computing device 106 includes, in some embodiments, at least one processing device 140, such as a central processing unit (CPU). A variety of processing devices are available from a variety of manufacturers, for example, Intel or Advanced Micro Devices. In this example, the computing device 106 also includes a system memory 142, and a system bus 144 that couples various system components including the system memory 142 to the processing device 140. The system bus 144 is one of any number of types of bus structures including a memory bus, or memory controller; a peripheral bus; and a local bus using any of a variety of bus architectures.

Examples of computing devices suitable for the computing device 106 include a server computer, a desktop computer, a laptop computer, a tablet computer, a mobile computing device (such as a smart phone, an iPod® or iPad® mobile digital device, or other mobile devices), or other devices configured to process digital instructions.

The system memory 142 includes read only memory 146 and random access memory 148. A basic input/output system 150 containing the basic routines that act to transfer information within computing device 106, such as during start up, is typically stored in the read only memory 146.

The computing device 106 also includes a secondary storage device 152 in some embodiments, such as a hard disk drive, for storing digital data. The secondary storage device 152 is connected to the system bus 144 by a secondary storage interface 154. The secondary storage devices 152 and their associated computer readable media provide nonvolatile storage of computer readable instructions (including application programs and program modules), data structures, and other data for the computing device 106.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 152 or memory 142, including an operating system 156, one or more application programs 158, other program modules 160 (such as the software engines illustrated and described in FIG. 3 and others discussed herein), and program data 162. The computing device 106 can utilize any suitable operating system, such as Microsoft Windows™, Google Chrome™, Apple OS, and any other operating system suitable for a computing device.

In some embodiments, a user provides inputs to the computing device 106 through one or more input devices 164. Examples of input devices 164 include a keyboard 166, mouse 168, microphone 170, and touch sensor 172 (such as a touchpad or touch sensitive display). Other embodiments include other input devices 164. The input devices are often connected to the processing device 140 through an input/output interface 174 that is coupled to the system bus 144. These input devices 164 can be connected by any number of input/output interfaces, such as a parallel port, serial port, game port, or a universal serial bus. Wireless communication between input devices and the interface 174 is possible as well, and includes infrared, BLUETOOTH® wireless technology, 802.11a/b/g/n, cellular, or other radio frequency communication systems in some possible embodiments.

In this example embodiment, a display device 176, such as a monitor, liquid crystal display device, projector, or touch sensitive display device, is also connected to the system bus 144 via an interface, such as a video adapter 178. In addition to the display device 176, the computing device 106 can include various other peripheral devices (not shown), such as speakers or a printer.

When used in a local area networking environment or a wide area networking environment (such as the Internet), the computing device 106 is typically connected to the network 114 through a network interface 180, such as an Ethernet interface. Other possible embodiments use other communication devices. For example, some embodiments of the computing device 106 include a modem for communicating across the network 114.

The computing device 106 typically includes at least some form of computer readable media. Computer readable media includes any available media that can be accessed by the computing device 106. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 106. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 2 is also an example of programmable electronics, which may include one or more such computing devices, and when multiple computing devices are included, such computing devices can be coupled together with a suitable data communication network so as to collectively perform the various functions, methods, or operations disclosed herein.

FIG. 3 is a schematic block diagram illustrating an example of the universal health identifier server 106. In this example, the universal health identifier server 106 includes a Master Patient Indexing (MPI) engine 190, a registration engine 192, a universal health identifier generator 194, a patient identifier management engine 196, a universal identifier distribution engine 198, a record indexing engine 200, and a record search engine 202.

Embodiments of the universal health identifier server 106 can include any one or more of these engines or generators 190, 192, 194, 196, 198, 200, and 202. Additionally, embodiments can include one or more computing devices, and any one or more of these engines or generators 190, 192, 194, 196, 198, 200, and 202 can operate on the one or more computing devices. For example, each can be operated on a separate computing device, or multiple can be operated on a single computing device. Further, in some embodiments multiple of the engines 190, 192, 194, 196, 198, 200, and 202 can be simultaneously operating on multiple different computing devices, and such computing devices can be in data communication with one another or operating autonomously from each other in different embodiments and implementations.

Some embodiments include a Master Patient Indexing (MPI) engine 190. The MPI engine 190 operates to match the incoming patient demographic record with existing patient records 116 in the UHID server 106. If the existing patient record 116 is found to match the incoming patient demographic record, the UHID associated to the patient record 116 will be distributed through the UHID distribution engine 198. If no match found, a new UHID will be generated to associate to this patient demographic record. All unique patient identifiers in this patient demographic record such as email address, cell phone number, etc. will be automatically associated to the UHID through corresponding hashing IDs.

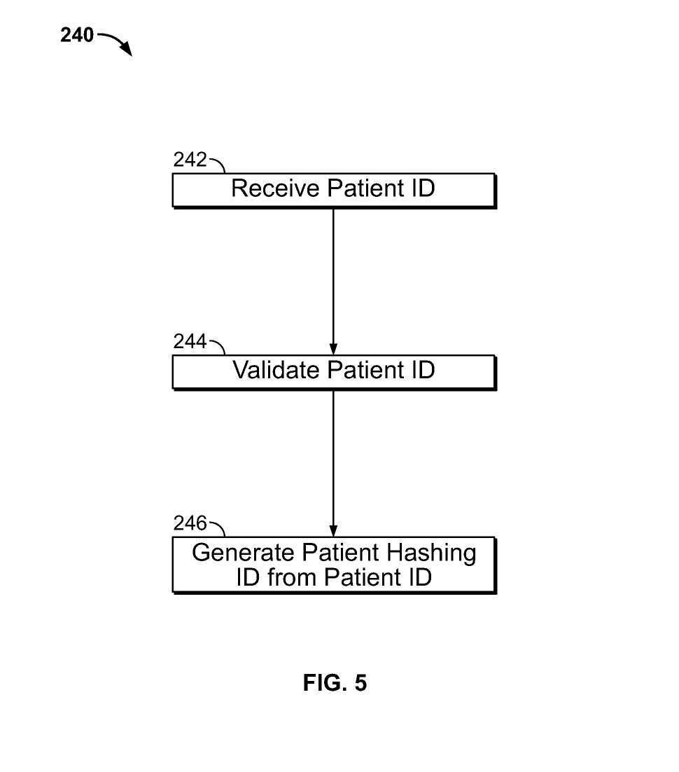

Some embodiments include a registration engine 192. The registration engine 192 operates to register a patient with the universal health identifier server. An example of the registration engine 192 is illustrated and described in more detail with reference to FIGS. 5-11.

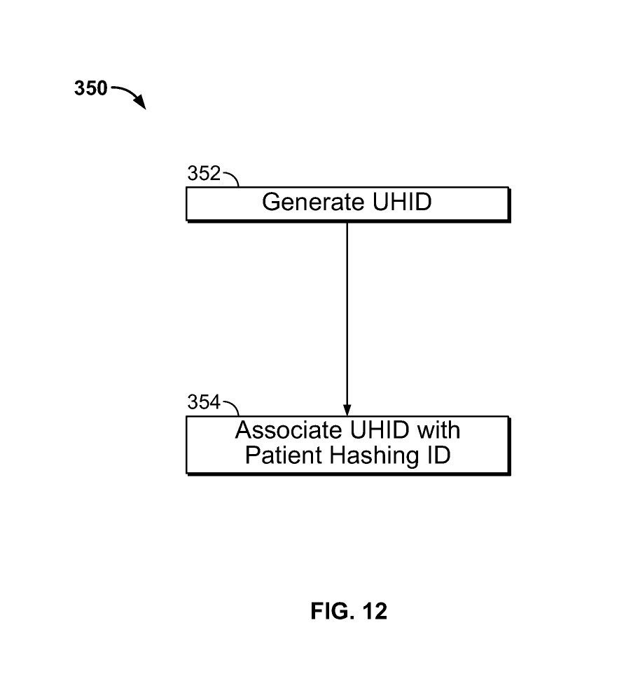

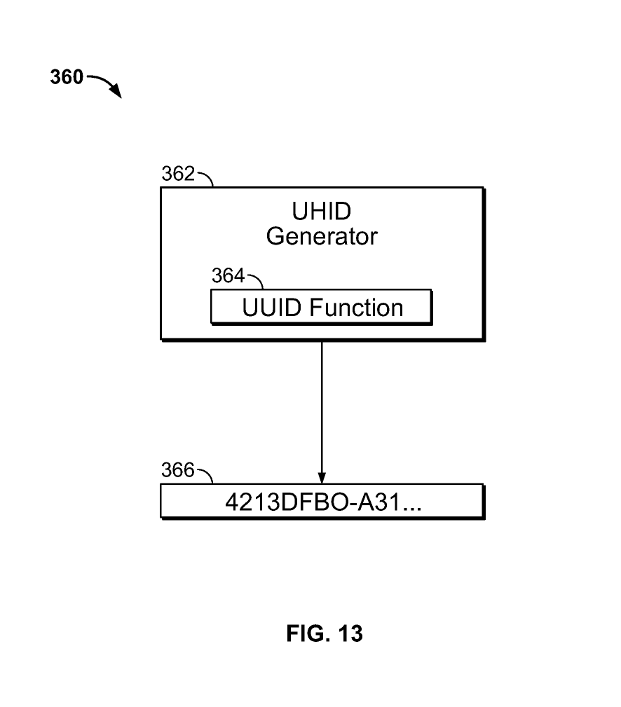

The universal health identifier generator 194 operates to generate a universal health identifier for a patient P. An example of the universal health identifier generator 194 is illustrated and described in further detail with reference to FIGS. 12-13.

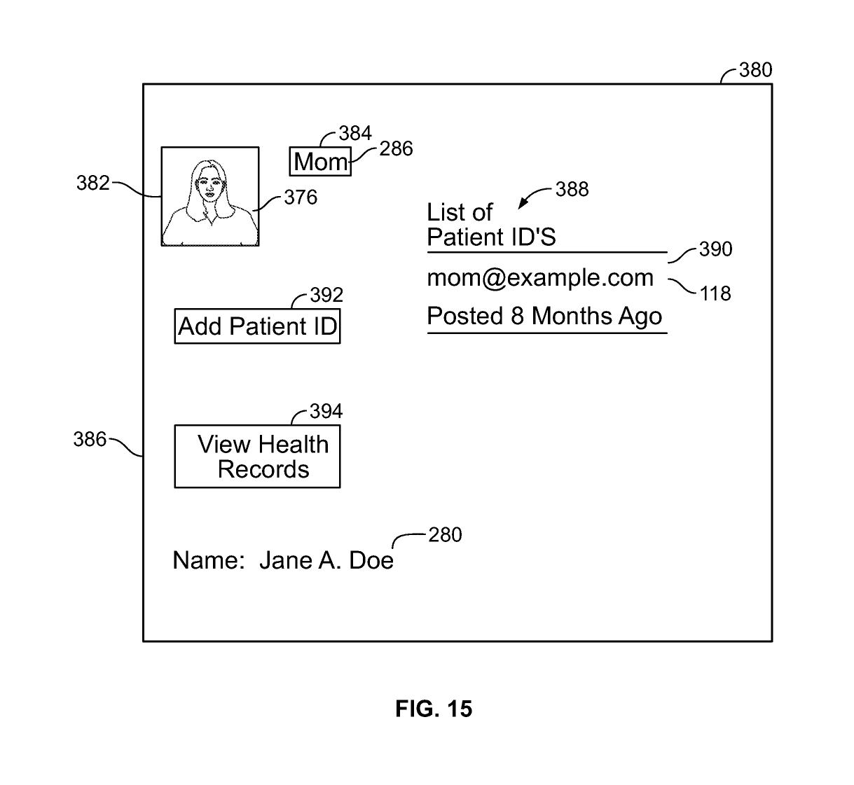

The patient identifier management engine 196 operates to manage one or more patient identifiers associated with the patient and the patient's universal health identifier. An example of the patient identifier management engine 196 is illustrated and described in further detail with reference to FIGS. 15-18.

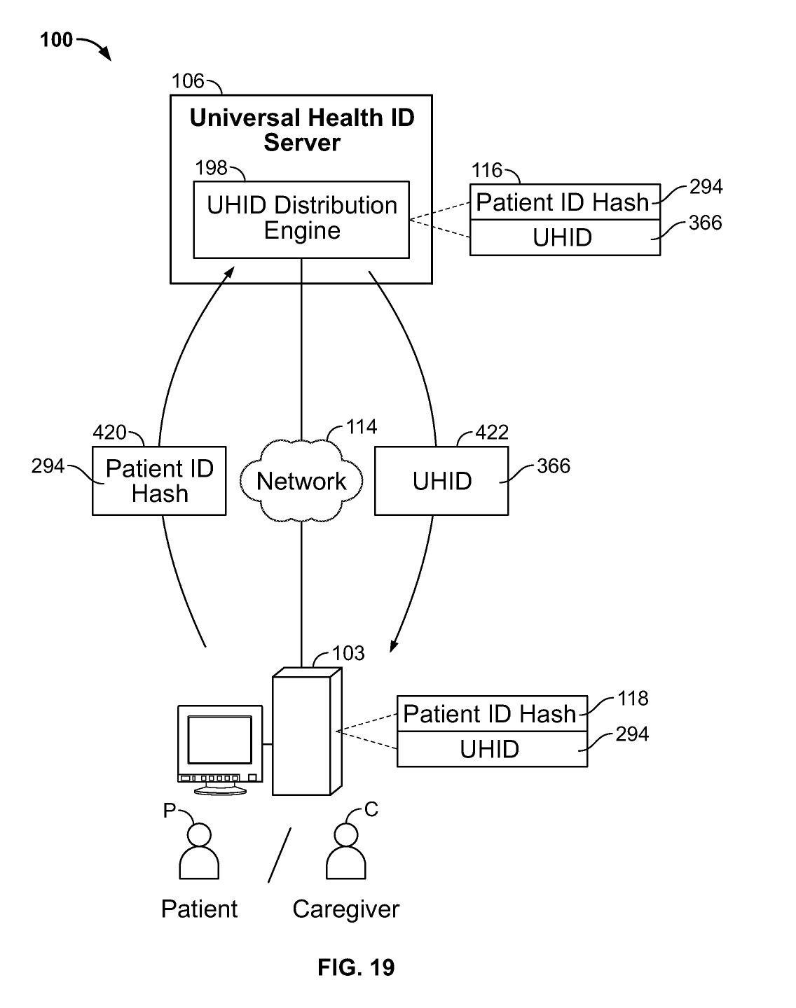

In some embodiments, the universal health identifier distribution engine 198 operates to distribute the universal health identifier of the patient. In some embodiments the universal health identifier is a randomly generated code having a significant number of digits. Although such an identifier can be easily used by computing devices, it can be difficult for a human to remember and use this identifier. Accordingly, in some embodiments the universal health identifier distribution engine 198 is provided, which permits a human, such as the patient P or the caregiver C to use a more human-friendly patient identifier to request and retrieve the universal health identifier from the universal health identifier server 106. An example of the universal health identifier distribution engine 198 are illustrated and described in more detail with reference to FIG. 19.

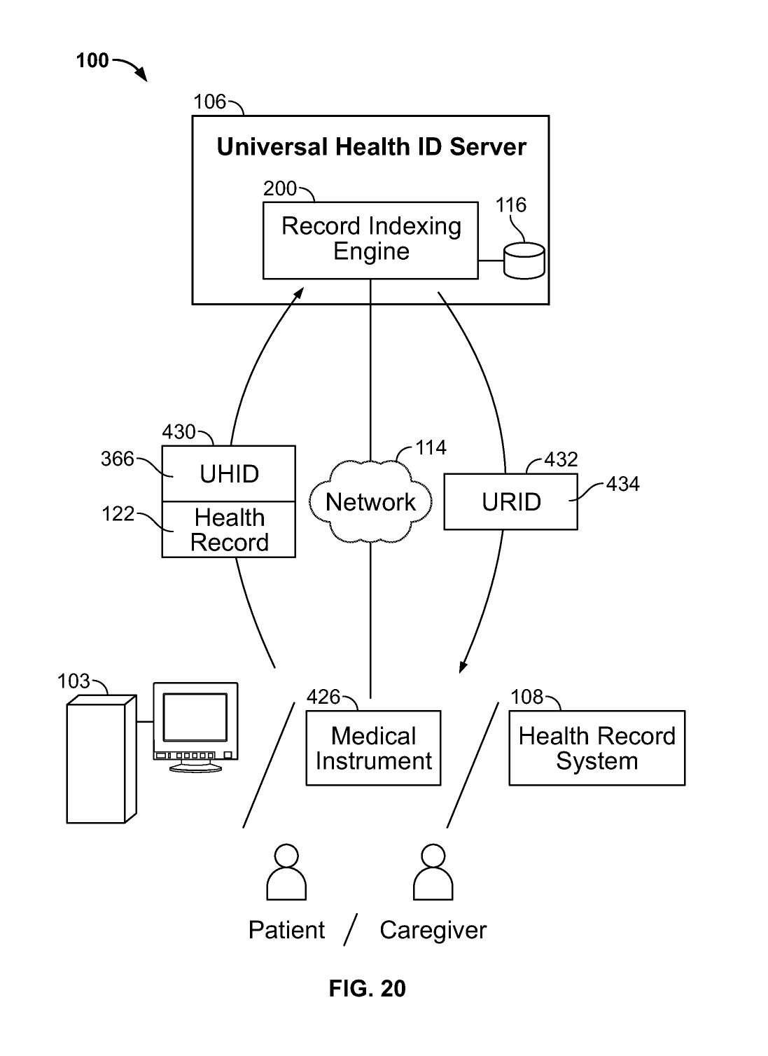

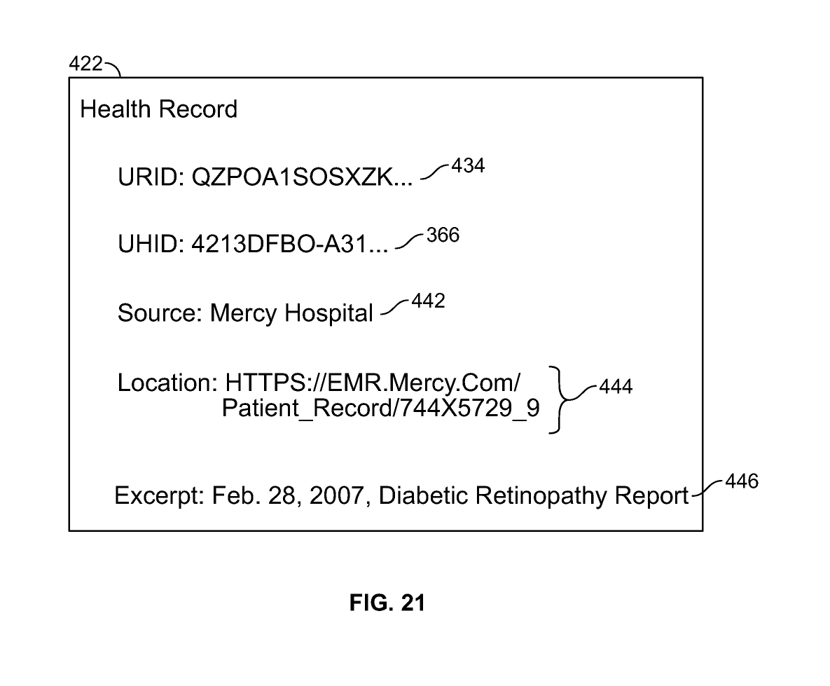

The record indexing engine 200 is provided in some embodiments to link health records 122 of the patient P with the universal health identifier 120. An example of the record indexing engine 200 is illustrated and described in more detail with reference to FIGS. 20-21.

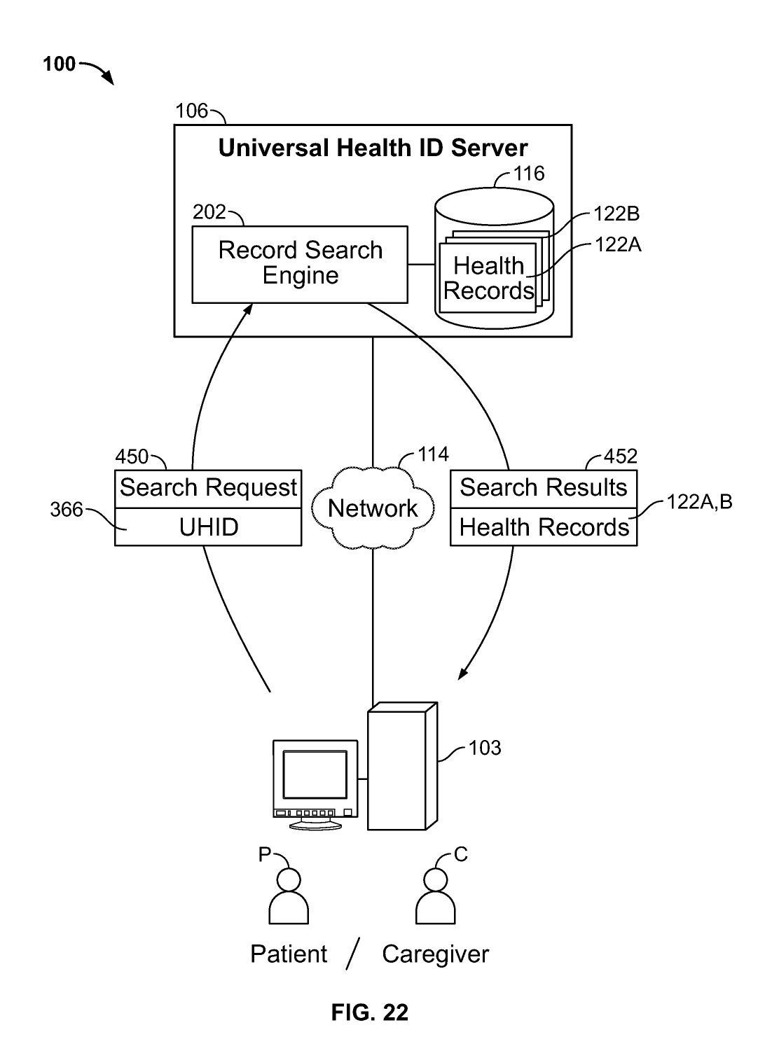

Some embodiments include the record search engine 202, which allows the health records associated with the patient P to be searched and identified. Examples involving the record search engine 202 are illustrated and described in more detail with reference to FIGS. 22-25.

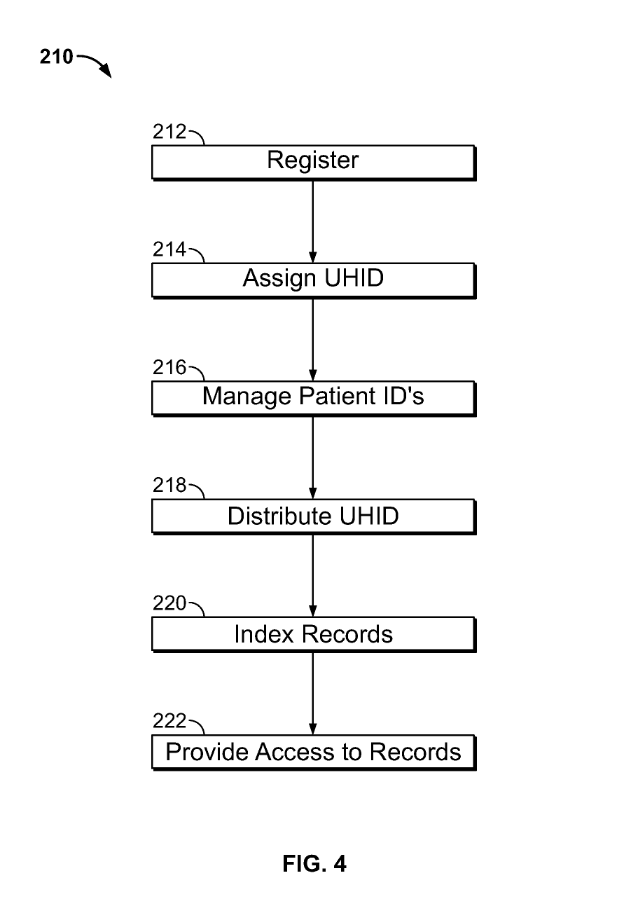

FIG. 4 is a flow chart illustrating an example method 210 of operating a universal health identifier server 106. In this example, the method 210 includes one or more of operations 212, 214, 216, 218, 220, and 220.

The operation 212 is performed to register a patient P. In some embodiments, the registration includes receiving information identifying the patient, such as the patient's name, or other identifying information. In some embodiments the registration operation 212 generates login credentials, such as a username and a password. The operation 212 is performed by the registration engine 192, in some embodiments, as discussed in further detail herein.

The operation 214 is performed to assign a universal health identifier 120 to the patient P. In some embodiments the operation 214 is performed by the universal health identifier generator 194, as discussed in further detail herein.

The operation 216 is performed to manage one or more of the patient identifiers associated with the patient P. In some embodiments the operation 216 is performed by the patient identifier management engine 196, as discussed in further detail herein.

The operation 218 is performed to distribute the universal health identifier 120. In one example, the operation 218 includes the receipt of a request for the universal health identifier 120 that includes a human-friendly patient identifier associated with the patient P. The operation 218 responds with the universal health identifier 120. In some embodiments the operation 218 is performed by the universal health identifier distribution engine 198, discussed in further detail herein.

The operation 220 is performed to index health records associated with the patient P. In some embodiments the operation 220 involves receiving the health records 122, and associating the health records with the universal health identifier 120. In some embodiments the health records 122 include links to the health records 110 stored in the health records system 108. In some embodiments the operation 220 is performed by the record indexing engine 200, discussed in further detail herein.

The operation 222 is performed to provide access to the health records 122. In some embodiments the operation 222 receives a search query, performs a search across the health records 122, and provides a set of search results identifying health records 122 that satisfy the search query. In other embodiments, the operation 222 provides displays the health records 122. In some embodiments the operation 222 displays the health records 122 and includes links to additional health data stored in health records 110 of the health records system 108. The operation 222 is performed by the record search engine 202, shown in FIG. 3, discussed in further detail herein.

FIGS. 5-11 illustrate an example of the registration engine 192, of the example universal health identifier server 106, shown in FIG. 3.

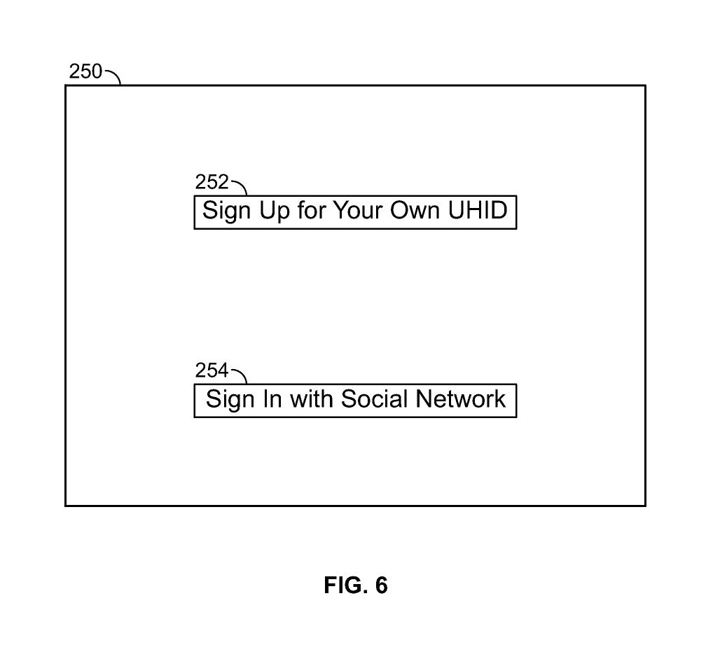

FIG. 5 is a flow chart illustrating an example method 240 of registering a patient. In this example, the method 240 includes operations 242, 244, and 246. Other embodiments include more or fewer operations, such as discussed herein. Additional examples of the method 240 are illustrated and described in more detail with reference to FIGS. 6-11.

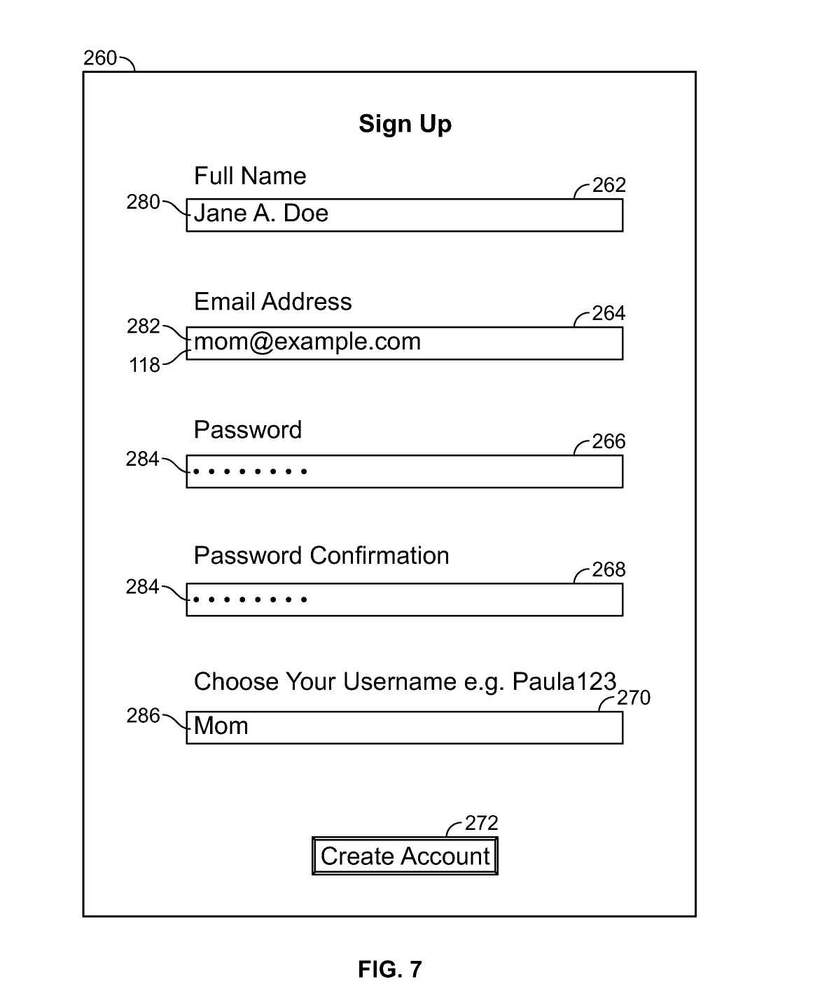

The operation 242 is performed to receive a patient identifier 118 (shown in FIG. 1). In some embodiments the patient identifier 118 is a human-friendly code that is associated with the patient. An example of a human-friendly patient identifier 118 is a code that is already familiar to the patient, or is relatively easily recognized or remembered by the patient. Examples of human-friendly patient identifiers 118 include the patient's telephone number (e.g., home, work, cell), home address, e-mail address, and government identification code (e.g., driver's license number, social security number), and a health care provider identification number (e.g., hospital admitting number). In some embodiments, a code is human friendly and easily recognized by the patient because it is a commonly used for other purposes. For example, an email address is human friendly and easily recognized by the patient. As another example, a driver's license number may not be typically memorized by a patient, but is still recognizable as a common identification code, and is typically kept with the patient on the patient's driver's license so that it is readily available. Patient identifiers 118 are typically formed of alphanumeric digits including common symbols, such as periods, dashes, and the like. Patient identifiers 118 typically include fewer than 32 characters, though typical embodiments can accept patient identifiers 118 having greater than 32 characters. Examples of the operation 242 are illustrated and described in further detail with reference to FIGS. 7 and 9-11.

Some embodiments include an operation 244, during which the patient identifier 118 is validated. The validation operation 244 performs a check to confirm that the patient identifier 118 is associated with the patient. For example, a patient's email address is received, and the validation operation 244 confirms the patient by sending an activation email to the patient for his/her confirmation. In another example embodiment, a database associated with the patient identifier is queried to confirm that the patient is associated with the patient identifier. For example, governmental database is used to confirm that a driver's license number is a valid number, and/or that the driver's license number is associated with the patient. As another example, a social network 112 (shown in FIG. 1) database is used to validate the patient identifier. Several examples of the operation 244 are illustrated and described in more detail herein, such as with reference to FIGS. 6-11. Additionally, some embodiments do not validate the patient identifier 118, and therefore do not perform operation 244.

In some embodiments, validation of the patient identifier comprises communicating with a social network system, a globally recognized avatar system, an electronic medical records system, and a driver's license database, such as to receive information about the patient, or to confirm the patient identifier is associated with the patient.

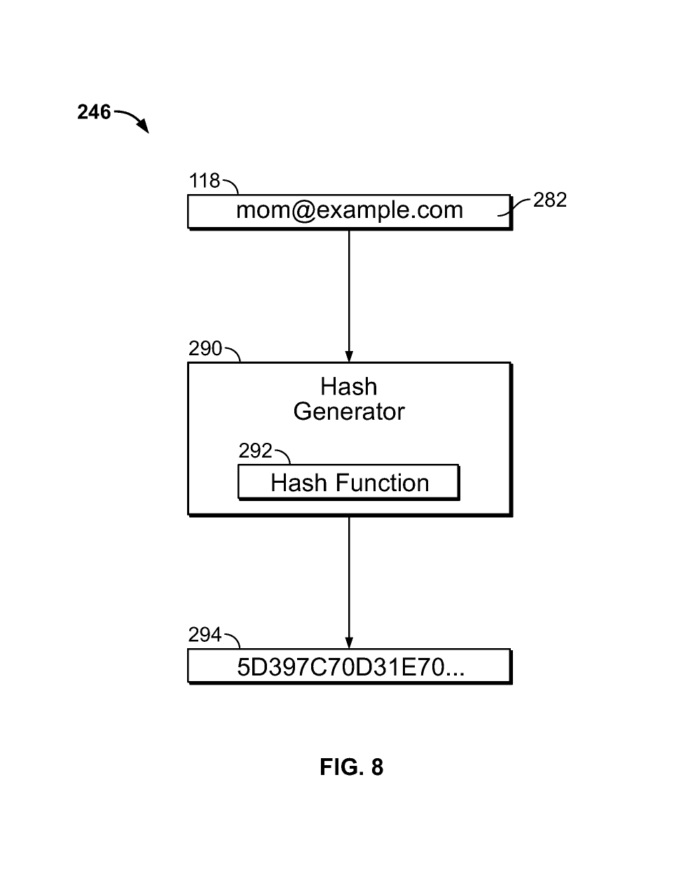

Some embodiments further include an operation 246, during which a patient hashing identifier is generated from the patient identifier 118. A patient hashing identifier can be used to improve security and patient confidentiality and privacy. The patient hashing identifier is code generated by a hashing function based on the patient identifier 118, from which it is difficult to reverse in order to obtain the original patient identifier 118. As a result, in some embodiments the patient identification system 100 can use the patient hashing identifier in communications sent through the system 100 in place of the actual patient identifier 118 to identify the patient P without using the actual patient identifier 118. In some embodiments the patient hashing identifier is generated by a hash generator, such as illustrated and described in more detail with reference to FIG. 8.

FIG. 6 is a screen shot of an example user interface 250 generated by the registration engine 192, shown in FIG. 3. In this example, the user interface 250 includes selectable controls 252 and 254.

In this example, the user interface 250 is shown as displayed on the patient computing device 104 (FIG. 1), such as may be generated by a web browser software application. In another possible embodiment, the user interface 250 is generated by a software application running on the patient computing device 104 that is in data communication with the registration engine 192. It is similarly noted that any of the user interfaces discussed herein can similarly be generated by any one or a combination of the computing devices discussed herein, in a web-based user interface context, an app based user interface context, or a software application based user interface context. Although one or more example embodiments are described in detail herein, other embodiments can be configured to operate in one or more of these other contexts as well.

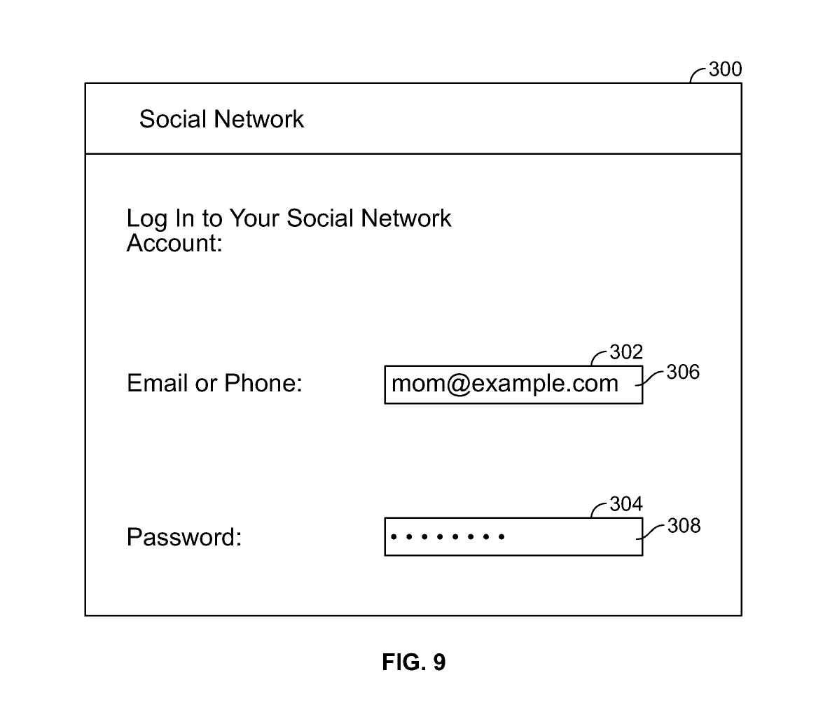

Some embodiments include multiple registration options, such as illustrated in FIG. 6. In this example, the patient is presented with two options including a manual registration option and a registration through a social network option. The first option is presented by the selectable control 252 that reads: “Sign up for your own UHID,” and the second option is presented by the selectable control 254 that reads: “Sign in with social network.” In this example, the selectable controls are selectable buttons. To proceed with the first option, the patient provides an input to the computing device 104 to select the selectable control 252, in which case the registration process proceeds such as depicted in the examples shown in FIGS. 7-8. To proceed with the second option, the patient provides an input to the computing device 104 to select the selectable control 254, in which case the registration process proceeds such as depicted in the examples shown in FIGS. 9-11. Some embodiments do not include the user interface 250, and can alternatively include only a single registration process, for example. Other embodiments can include additional or different registration processes than the two represented in FIG. 6.

FIGS. 7-8 illustrate an example of a manual registration process.

FIG. 7 is a screen shot of an example registration user interface 260. In this example, the user interface 260 includes registration fields 262, 264, 266, 268, and 270 and a register control 272. The registration fields are configured to receive inputs 280, 282, 284, and 286, for example. Some embodiments include more, fewer, or different registration fields, which are configured to receive more, fewer, or different inputs.

A full name field 262 is provided to receive the full name 280 of the patient. In another embodiment multiple fields can be used to obtain portions of the patient's name, such as the first, middle, and last names.

An e-mail address field 264 is provided to receive an e-mail address 282 of the patient. In this example, the e-mail address 282 is also the patient identifier 118.

A password field 266 is provided to receive a password 284 chosen by the patient. In some embodiments, as shown in FIG. 7, the user interface 260 does not display the characters of the password 284 that are entered so that any other people that may be viewing the screen with the patient cannot see the password chosen by the patient. The password field 268 is provided to receive a second entry of the password 284 from the patient to allow the two entries to be compared to ensure that they match, to reduce the chance of unintentional errors.

A username field 270 is provided to receive a username 286 from the patient. The username 286 and the password 284 can be used by the patient to login to the universal health identifier server 106 in the future, for example.

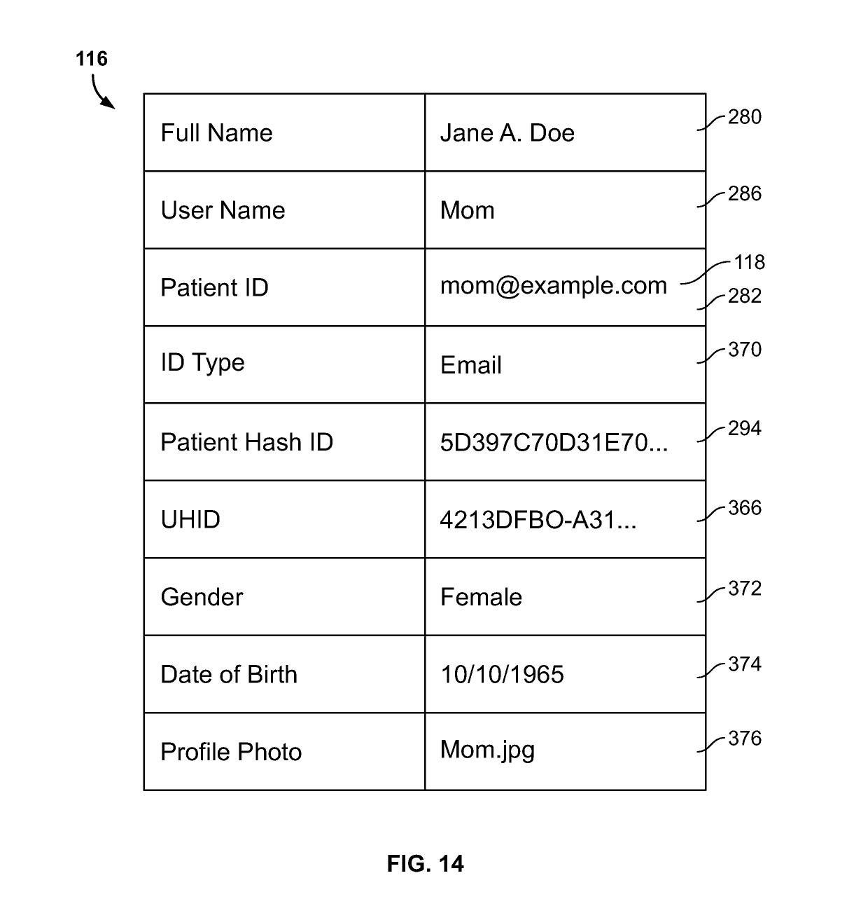

Once the patient has entered the registration information, the register control 272 is selected to proceed with the registration process. In some embodiments, after the register control 272 is selected, the registration engine 192 generates a new record 116 in the database (FIG. 1) and stores at least some of the registration information 280, 282, 284, and 286 therein, such as shown in FIG. 14.

Some embodiments further include a validation operation (e.g., 244, FIG. 5). For example, in some embodiments the registration engine 192 sends an e-mail to the e-mail address 282 including a link or verification code, and prompts the patient to check his or her e-mail and select the link or enter the verification code, for example. This validation operation can be used to confirm that the patient has access to the e-mail address 282, for example. Other validation operations can also or alternatively be performed.

FIG. 8 illustrates an example of the operation 246 (FIG. 5) that generates a patient hashing identifier 294 from a patient identifier 118. A hash generator 290 is also shown, including a hash function 292.

The hash generator 290 operates to receive a first code and output a second code based on the first code. In some embodiments, the hash generator 290 includes and utilizes a hash function 292 to generate the second code based on the first code. In some embodiments the hash generator 290 always generates the same second code based on the same first code being input into it. However, the hash function 292 is selected so that the process is not easily reversible. In other words, if only the second code is obtained, it is difficult to determine the first code based solely on the second code.

In this example shown in FIG. 8, the patient identifier 118, such as the patient's e-mail address 282 (“mom@example.com”), is provided to the hash generator 290. The hash generator 290 processes the patient identifier 118 using the hash function 292 to generate the patient hashing identifier 294 (“5d397c70d31e70db872eaae51bb3428b”). The patient hashing identifier 294 can be used in communications within the patient identification system 100 and across the network 114, and even if those communications were obtained by an unauthorized individual, that confidentiality and privacy of the patient is maintained because the communication does not include the patient identifier 118, and the unauthorized individual is unable to compute the patient identifier 118 from the patient hashing identifier 294.

One example of the hash function 292 is the MD5 hashing algorithm. This algorithm is capable of receiving inputs of variable length (such as in a 43-byte ASCII input format) and generates a fixed-length output of 128 bits. The 128-bit (16-byte) MD5 hash is typically represented as a sequence of 32 hexadecimal digits. Using the MD5 hashing algorithm, the example patient identifier 118 of “mom@example.com” generates a patient hashing identifier 294 of “abbb6c4a7af50e7e191f81797a125458”.

Another example of a hash function 292 is SHA-1, which generates a 160-bit (20-byte) hash value, which is typically represented by 40 hexadecimal digits. SHA stands for “Secure Hash Algorithm.” Other SHA functions can also be used, such as SHA-0, SHA-2, and SHA-3. In some embodiments the hash function is a cryptographic hash function.

Various types of hash functions can be used in various embodiments, such as selected from one of the following types: hash, HAIFA structure, Merkle-Damgard construction, Merkle tree NLFSR, Drawers constructions, Sponge function, Unique Block Iteration, non-collision-resistant PRF, and Wide Pip Merkle-Damgard construction.

FIGS. 9-11 illustrate an example of a registration process involving the social network 112 (shown in FIG. 1).

In this example, a patient chooses to register by utilizing the social network 112. As one example, the patient is first prompted to provide login credentials for the social network 112, as shown in FIG. 9.

FIG. 9 is a screen shot of an example social network login user interface 300. In this example, the login user interface 300 includes login fields 302 and 304, which are provided to receive login information 306 and 308.

The login field 302 is provided to obtain a username or other social network identifier 306. In this example, the login user interface 300 prompts the patient to enter into the login field 302 patient's e-mail address or phone number. In some embodiments the social network identifier 306 is the same as the patient identifier 118, while in other embodiments the social network identifier 306 is different than the patient identifier 118.

The login user interface 300 also includes a password field 302 that is used to prompt the patient to enter a password 308.

In some embodiments the user interface 300 is generated by the social network 112 and displayed on the patient computing device 104. In some embodiments the user interface 300 is a pop-up window. In some embodiments the user interface 300 appears to be generated by the universal health identifier server 106, and may be generated by the server 106, or may be generated by the social network 112 in such a manner that the universal health identifier server 106 does not receive the social network identifier 306 and the password 308 at this time, even though it may appear to the user that the user interface 300 as though it is. In either case, the social network identifier 306 and the password 308 are sent to and received by the social network 112, which compares the login credentials to a database to confirm that they match the credentials stored in the database.

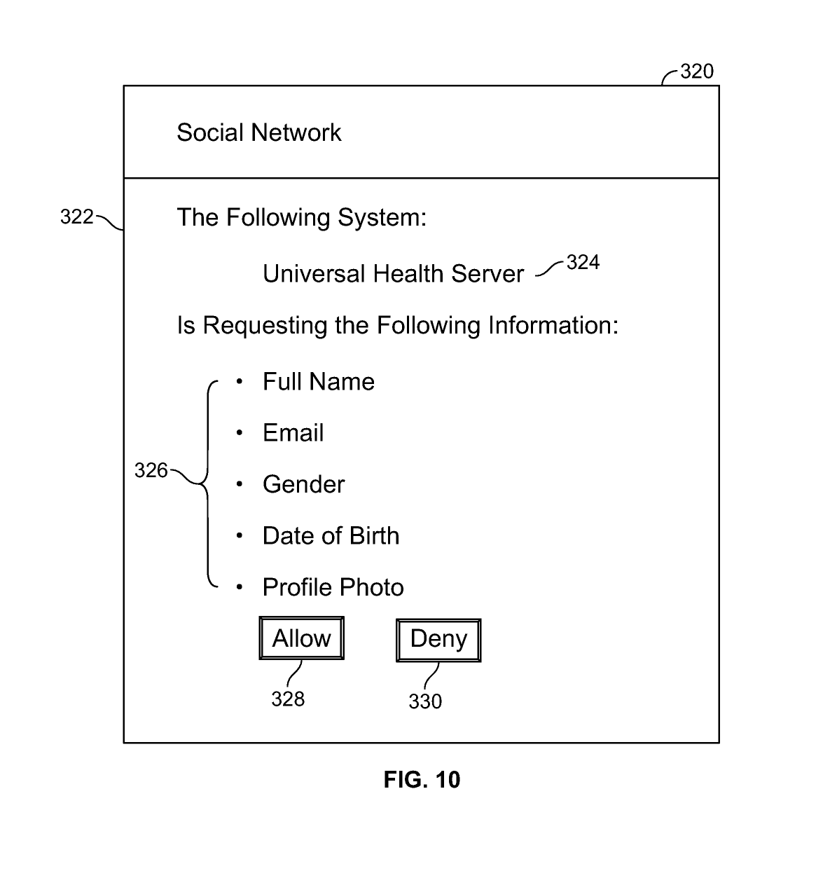

A request is submitted from the universal health identifier server 106 to the social network 112 for information associated with the patient for use during the registration process. Before sending the information, the social network typically prompts the patient to confirm that the sharing of such information is acceptable, such as shown in FIG. 10.

FIG. 10 is a screen shot of an example authorization user interface 320, such as may be generated by the social network 112, in some embodiments. In this example, the user interface 320 includes an authorization request 322, an identification 324 of the requesting system, and a listing 326 of the information that has been requested. The example user interface 320 also includes selectable controls 328 and 330 to allow or deny the request.

The authorization request 322 is presented to the patient P before providing any private information to the universal health identifier server 106 to alert the patient that certain information is being requested, and to obtain permission from the patient to share that information.

In this example, the authorization request 322 includes an identification 324 of the system making the request, such as the universal health identifier server 106.

The authorization request 322 also includes a listing 326 of the information that has been requested, in some embodiments. In this example the requested information includes the patient's full name, e-mail address, gender, date of birth, and profile photo. Other embodiments can include a request for more, less, or different information, and such information can be included in the listing 326. It is also possible in some embodiments that prior approval of the information transfer can be obtained from the patient, such that the separate request is not displayed.

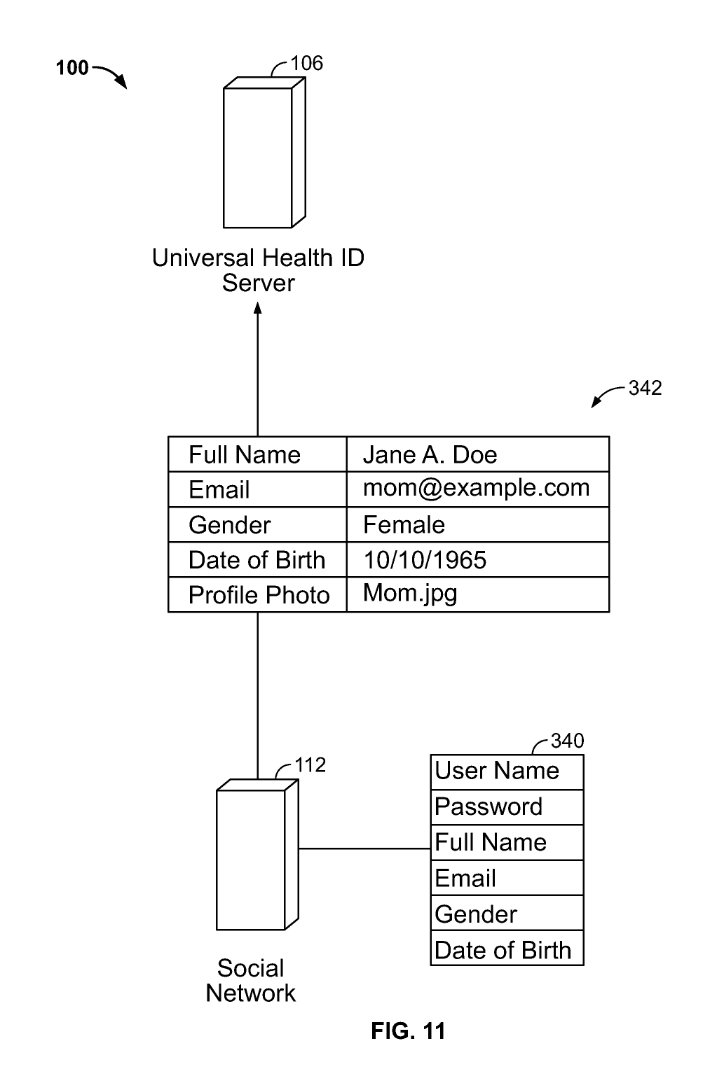

The patient can then review the request and determine whether to allow the transfer of the information by selecting the allow control 328, or deny the transfer by selecting the deny control 330. If allowed, the information is transferred, such as shown in FIG. 11. Otherwise, the process is canceled, and the user can be prompted to complete the manual registration process, or to try again.

FIG. 11 is a schematic diagram illustrating a portion of the patient identification system 100, including the social network 112 and the universal health identifier server 106. FIG. 11 also illustrates a method of transferring patient information to the universal health identifier server 106. The social network 112 database 340 is also shown, along with a patient information message 342.

The social network 112 includes a database 340 that contains patient information. The information may have been previously supplied by the patient to the social network 112, for example.

After a request for the patient's information is received by the social network 112, and in some embodiments after the request is approved by the patient (FIG. 10), the social network retrieves the requested patient information from the database 340 and sends a patient information message 342 to the universal health identifier server including the requested patient information. In this example, the patient information message 342 includes the patient's full name, e-mail address, gender, date of birth, and profile photo. As discussed herein, the message 342 can also include more, less, or different information in other embodiments. For example, in some embodiments the social network 112 sends at least a patient identifier, such as an e-mail address, or other patient identifier. In another embodiment the social network 112 sends at least the patient's name and a patient identifier.

Once received, the universal health identifier server 106 uses the received information to register an account for the patient, and saves the patient information in the universal health identifier server 106 database. In some embodiments, the registration process includes generating a patient hashing identifier 294 for one or more of the patient identifiers received in the patient information message from the social network, such as through the example system and method shown in FIG. 8.

FIGS. 12-14 illustrate an example of the universal health identifier generator 194 of the example universal health identifier server 106, shown in FIG. 3

FIG. 12 is a flow chart illustrating an example method 350 of generating a universal health identifier for a patient. In this example, the method 350 includes operations 352 and 354.

The operation 352 is performed to generate a universal health identifier. The universal health identifier is a code that can be used to uniquely identify the patient. The code is universal because it can be used by any caregiver, for example, to uniquely identify the patient. In some embodiments only a single universal health identifier is assigned to an individual patient, even if that patient has multiple patient identifiers. An example of the operation 352 is illustrated and described in further detail with reference to FIG. 13.

Once the universal health identifier has been generated, the operation 354 is performed to associate the universal health identifier with the patient hashing identifier. In some embodiments the universal health identifier is also associated with the patient identifier. An example is shown in FIG. 14.

FIG. 13 illustrates an example of the operation 352 (FIG. 12) that generates a universal health identifier 366 for a patient. A universal health identifier generator 362 is also shown, including a universally unique identifier (UUID) function 364. The universal health identifier 366 is an example of the universal health identifier 120, shown in FIG. 1.

The universal health identifier generator 362 operates to generate a universal health identifier 366 for a patient. In one possible embodiment, the universal health identifier generator 362 maintains a record of all previously assigned universal health identifiers, and generates a new universal health identifier 366 that is different from all previously assigned universal health identifiers, such as by assigning the identifiers consecutively, or by randomly generating the identifier and checking to ensure that the randomly generated identifier as not been previously assigned.

In another possible embodiment, the universal health identifier generator 362 includes a universally unique identifier function for generating universally unique identifiers. Universally unique identifiers are generated in such a way, and have such a large quantity of possible identifiers, that is extremely unlikely that any two will be the same. As one example, the universally unique identifier (as well as the universal health identifier) is a 16-octet (128-bit) number, which can be represented by 32 lowercase hexadecimal digits. In some embodiments the universal health identifier is represented with one or more hyphens, such as including four hyphens and a total of 36 characters. An example of a universal health identifier is: “4213dfb0-a31a-0130-aea1-66711895a888.”

Various universally unique identifier functions can be used, such as any one of the Version 1 (MAC address), Version 2 (DCE Security), Version 3 (MD5 hash), Version 4 (random), or Version 5 (SHA-1 hash) UUID functions.

The universally unique identifier generated by the universal health identifier generator 362 is assigned to the patient as the patient's universal health identifier 366.

FIG. 14 is a schematic diagram illustrating an example of a patient record 116 of the universal health identifier server 106. In this example the record 116 includes the patient's full name 280, username 286, patient identifier 118, ID type 370, patient hashing identifier 294, universal health identifier 366, gender 372, date of birth 374, and profile photo 376.

The patient record 116 is stored in a database of the universal health identifier server in some embodiments. The record 116 can include a database record, such as including one or more tables (such as in the case of a relational database) or can be stored as a set of interrelated nodes and edges (such as in the case of a graph database). In another embodiment, the database record is a document in a NoSQL database. Other types of database record or other data storage formats can also be used in other embodiments.

In the illustrated example, the patient's record 116 includes a table in which all data items stored in the record 116 are associated with each other, and more specifically, as associated with the patient. Accordingly, the record 116 indicates that the patient P (FIG. 1) has a full name 280 of “Jane A. Doe,” a username 286 of “mom,” a patient identifier 118 of “mom@example.com” which is an e-mail address as indicated by the ID type 370. The patient hashing identifier is “5D397c70D31E70 . . . ” and the universal health identifier is “4213dfb0-a31 . . . . ” The example record 116 further includes the patient's gender 372 of “female,” the date of birth 374 of “10/10/1965,” and the profile photo 376 of mom.jpg. Other embodiments include other information in the record 116, such as discussed herein. A similar record 116 is maintained for each patient that has registered with the universal health identifier server 106, in some embodiments.

FIGS. 15-18 illustrate an example of the patient identifier management engine 196 of the example universal health identifier server 106, shown in FIG. 3.

FIG. 15 is a screen shot of an example user interface 380, such as generated by the patient identifier management engine 196. In this example, the user interface 380 includes a profile photo display 382, username display 384, name display 386 and list of patient identifiers 388 including a patient identifier display 390. The profile photo display 382 displays the patient's profile photo 376. The username display 384 displays the patient's username 286. The name display 386 displays the user's full name 280. The list of patient identifiers 388 displays all patient identifiers 118 that are currently associated with the patient, such as the patient identifier 118 shown in the patient identifier display 390.

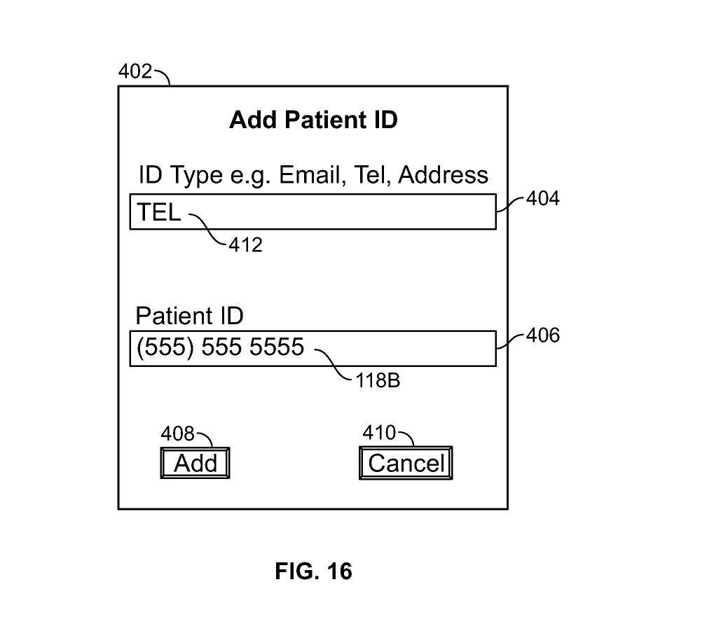

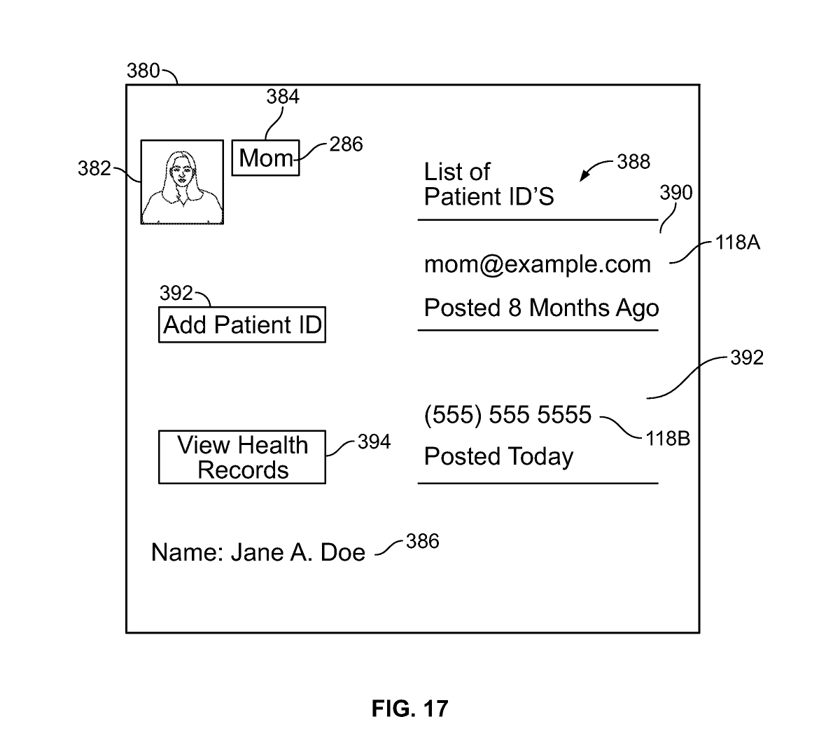

The user interface 380 also includes an add patient identifier control 392, and a view health records control 394. In some embodiments the selection of the add patient identifier control 392 is selected to associate another patient identifier 118 with the patient, and accordingly, with the patient's universal health identifier 366 (such as shown in FIG. 14). Adding additional patient identifiers is illustrated and described in more detail with reference to FIGS. 16-17.

The view health records control 394 is selected to view or search for health records associated with the patient and the patient's universal health identifier. Examples illustrating the retrieval and display of health records are illustrated and described in more detail with reference to FIGS. 21-25.

FIG. 16 is a screen shot of an example user interface 402, such as generated by the patient identifier management engine 196 after selection of the add patient identifier control 392 (FIG. 15). In this example, the user interface 402 includes an identifier type field 404, a patient identifier field 406, an add control 408, and a cancel control. Also shown in FIG. 16 is an example of the data provided by the user, such as an identifier type 412 and a patient identifier 118B.

The user interface 402 prompts the user to enter another patient identifier to be associated with the patient, and the patient's universal health identifier. In this example, the user interface 402 prompts the user to indicate the type of patient identifier being provided in field 404, and to provide the patient identifier in field 406.

The identifier type need not be requested in some embodiments, but is useful information to obtain. As one example, by knowing the type of identifier the format for displaying the identifier can be adjusted. For example, a telephone number can be formatted to separate the first three digits (relating to the area code), and to show the remaining digits grouped as three digits and four digits, respectively. As another example, if the identifier type is an e-mail address, the universal health identifier server 106 may be able to use that e-mail address for further communication with the patient, such as to send alerts or other notices. Further, the identifier type can be helpful in identifying a process for verifying or validating a patient identifier. For example, an e-mail address can be verified and validated by sending a test e-mail to that address and requesting that the patient click a link contained in the e-mail or enter data communicated in the e-mail. That same process may not be suitable for other types of patient identifiers. For example, a telephone number can be verified and validated through a test telephone call, an address can be verified and validated by sending physical mail to the address. Alternatively, or additionally, one or more databases can be consulted for various types of patient identifiers, such as a telephone directory, address directory, health record, and the like.

The patient identifier 118B is received at patient identifier field 406. In this example the patient identifier 118B is a telephone number.

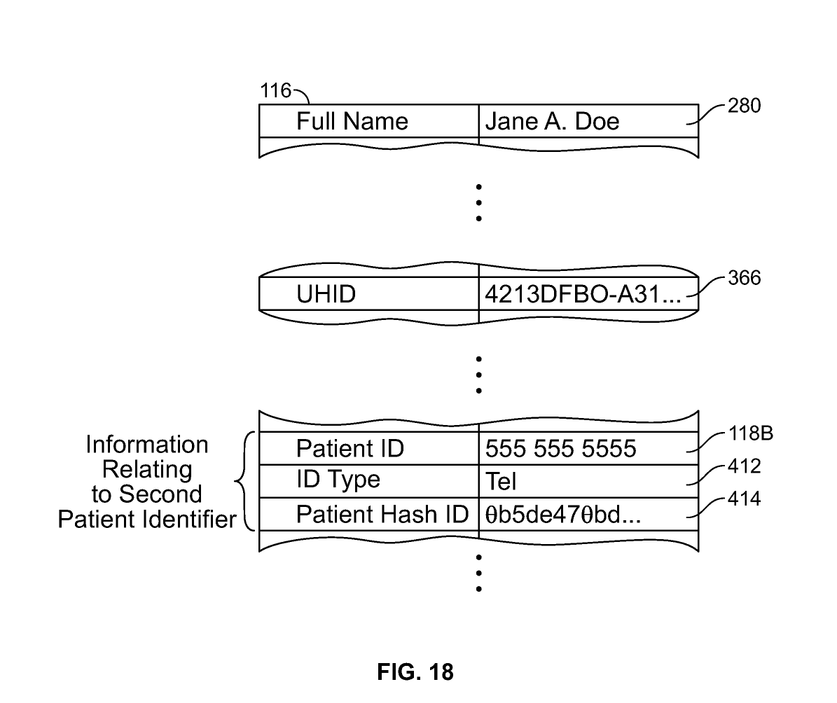

In some embodiments an add control is selected by the user once the information has been entered to proceed with adding the new patient identifier to the patient's record 116, as shown in FIG. 18. In some embodiments the information is verified for uniqueness and/or validated, as discussed herein, prior to adding the information to the patient's record 116. For example, if the same patient identifier has been associated with another UHID, then an error message will indicate that the patient identifier cannot be added. In some embodiments, when the telephone number is used as a patient identifier, if the same phone number has been used by another patient as a patient identifier, then it cannot be associated to the other patient anymore, however, it is still ok for other patient to use the same phone number as contact information. even if the patient's telephone number changes, it may still be desired by the patient to continue using the telephone number as an identifier. Transferring of patient identifiers is also possible in other embodiments, however, and a mechanism can be provided for requesting a transfer of a patient identifier, for example, or disputing a patient identifier.

The cancel control 410 is selected to return to the user interface 380 shown in FIG. 15 without adding a new patient identifier.

FIG. 17 a screen shot of another example of the user interface 380 shown in FIG. 15, further including a second patient identifier 118B.

In this example, after adding a new patient identifier as illustrated and described with reference to FIGS. 15-16, the user interface 380 now includes an updated list of patient identifiers 388, including the previous patient identifier 118A and the new patient identifier 118B, shown in the patient identifier displays 390 and 392, respectively.

FIG. 18 is a schematic block diagram illustrating another example of the patient record 116 after the addition of a second patient identifier 118B. This example shows that the patient record 116 includes, for example, the patient's name 280, the universal health identifier 366, the previously provided patient identifier 118A (FIG. 14) and/or other information in the example shown in FIG. 14, the second patient identifier 118B, the identifier type 412, and the patient hashing identifier 414.

As shown, the patient record 116 is updated to include the information relating to the second patient identifier 118B, including the actual patient identifier 118B (“5555555555”), and the identifier type 412 (“TEL”). In addition, in some embodiments a patient hashing identifier 414 is generated based on the patient identifier 118B, such as by the hash generator 290 illustrated and described with reference to FIG. 8.

Accordingly, the information relating to the second patient identifier (including the patient identifier 118B, the identifier type 412, and the patient hashing identifier 414) is associated with both the patient and the patient's universal health identifier 366. In some embodiments, however, a single universal health identifier is associated with the patient, regardless of how many patient identifiers 118 are used.

Additional patient identifiers can be added as desired. As one example, a particular hospital (or other health care provider) may choose to add patient identifiers to each of its patient's records 116, where the patient identifier is the patient number at that hospital. In this way the hospital can continue to refer to the patient by the existing patient identifier used at that hospital, and the universal health identifier server 106 can also uniquely identify that patient, the patient's universal health identifier, and the patient's health records, for example.

In some embodiments the patient identifier management engine 196 also allows patient identifiers to be changed. This can be accomplished by deleting old patient identifiers and adding new patient identifiers, or by modifying an existing patient identifier, for example. As one example, if the patient's telephone number changes, the patient may want to change the patient identifier associated with his or her telephone number to the new number. Similar changes may occur with other types of patient identifiers, such as e-mail addressed, home addresses, and the like. In some embodiments the patient hashing identifier is also changed when the patient identifier is changed. Other patient information can also be changed in some embodiments, such as the patient's name.

FIG. 19 illustrates an example of the universal health identifier distribution engine 198, of the example universal health identifier server 106, shown in FIG. 3. FIG. 19 also illustrates an example method of distributing a universal health identifier based on a patient identifier. In some embodiments the universal health identifier is generated in a form that, although useful to uniquely identify a patient, is not easily remembered by a human. Therefore, some embodiments include and provide a UHID distribution service that allows the patient, caregiver, or other user to request the universal health identifier using a patient identifier that is more easily remembered or recognizable by the patient or caregiver.

FIG. 19 is a schematic block diagram illustrating another example of a portion of the patient identification system 100, shown in FIG. 1. More particularly, FIG. 19 illustrates a universal health identifier distribution function performed by some embodiments of the universal health identifier server 106. In this example, the patient identification system 100 includes the user computing device 103, and the universal health identifier server 106 including the UHID distribution engine 198 and the patient record 116, which communicate across the data communication network 114. The patient record 116 includes the patient hashing identifier 294 and the universal health identifier 366. The patient identifier 118, a request 420, and a response 422 are also shown.

In this example, a user such as the patient P or caregiver C interacts with the user computing device 103 to initiate a request for the patient's universal health identifier from the universal health identifier server 106. For example, the user computing device 103 prompts the user to enter or select the patient identifier 118. As discussed herein, the patient identifier 118 is typically a human-friendly code, such as the patient's telephone number, e-mail address, home address, etc.

Upon receipt of the patient identifier 118, the user computing device 103 generates a patient hashing identifier from the patient identifier 118, such as by using a hash generator 290, discussed in FIG. 8.

A request 420 is then generated and sent from the user computing device 103 to the universal health identifier server 106, which includes a request for the universal health identifier, and the patient hashing identifier 294. Because the server knows the patient hashing identifier 294, the request can use this in place of the patient identifier 118 in the request, so that even if the request is intercepted by an unauthorized party, the request does not contain any information that can be used by the unauthorized party to identify the patient P, thereby maintaining the patient's privacy and confidentiality, for example.

The request 420 is received at the universal health identifier server 106 and is processed by the UHID distribution engine 198. In some embodiments, the universal health identifier server 106 receives the request using a RESTful application programming interface (API). As one example, the request 420 is sent using a platform service GET API (using http or https) as follows: www.example.com/uhid/[hash], where “example” is the domain of the UHID server 106, and “[hash]” is the patient ID hash 294.

In this example, the UHID distribution engine 198 performs a query of the patient records 116 to identify the patient record 116 having a patient hashing identifier that matches the patient hashing identifier 294 contained in the request 420. Once found, the patient record 116 is used to retrieve the universal health identifier 366 associated with the patient identification hash.

A response 422 is then generated by the UHID distribution engine 198 and sent to the user computing device that initiated the request 420. The response 422 includes the universal health identifier 366 of the patient.

The user computing device and/or the patient, caregiver, or other user, can then use the universal health identifier 366 for any suitable purpose, such as discussed in further detail herein, such as submitting or retrieving health records associated with the patient, for example. An example submission of a health record is illustrated and described in more detail with reference to FIG. 20.

FIGS. 20-21 illustrate an example of the record indexing engine 200, of the example universal health identifier server 106, shown in FIG. 3. In some embodiments the universal health identifier server 106 includes health information associated with the patient. In some embodiments the actual medical record is stored along with all confidential and personal medical information. In other embodiments, however, the actual medical records are not stored but information about the records is stored, such as information about what the record is and a link to the record in a separate health record system 108. A benefit of not storing confidential or private health information of the patient in the patient record 116 is that the universal health identifier server 106 does not require strict privacy and security measures because the information contained therein is not sensitive confidential or private information, for example. In any event, in some embodiments the information to be stored in the patient's record 116 at the universal health identifier server 106 is sent and stored in the exemplary manner shown in FIGS. 20-21.

FIG. 20 is a schematic block diagram illustrating another example of a portion of the patient identification system 100, shown in FIG. 1. More particularly, FIG. 20 illustrates a record indexing function performed by some embodiments of the universal health identifier server 106. In this example, the patient identification system 100 includes the user computing device 103, a medical instrument 426, the health record system 108, the universal health identifier server 106 including the record indexing engine 200 and patient record 116, which communicate across the data communication network 114. Also shown are a request 430, a response 432, a universal health identifier 366, a health record 122, and a universal record identifier 434.

The example illustrates that the request 430 can be generated by a variety of different sources. One example source is the user computing device 103. Another example source is a medical instrument 426. A medical instrument 426 may be any of a variety of devices capable of generating or transmitting a health record associated with the patient. Examples of medical instruments 426 include a bedside or other patient monitoring device (such as a vital signs monitor), a blood pressure monitor, a weight scale, an activity sensor, a laboratory instrument, and a wide variety of other medical instruments. A further example source is a health record system 108. An example of a health record system 108 is an electronic medical records system, an electronic health record system, a health information exchange, a caregiver or health care provider medical record system, or other health record systems. Other sources can also be used in other embodiments.

In order to inform the universal health identifier server 106 to the existing of the health record 122, a request 430 is submitted to the universal health identifier server 106 asking the universal health identifier server 106 to index the health record 122 in the patient's record 116. In this example, the request includes the universal health identifier 366 of the patient (such as can be obtained as shown in FIG. 19), and the health record 122. As one example, the request 430 is formatted and sent using the platform service API (such as using https) in a format such as: www.example.com/[uhid]/[record type]/[filename], where “example” is the domain of the UHID server 106, “[uhid]” is the patient's universal health ID, “[record type]” is a record type, such as “ecg” for a record from an ECG device, and “[filename]” is the name of the file containing the health record 122 (e.g., myECG.zip). The health records can be provided in a variety of different formats, such as zip, h17, and any other desired file format.

The health record 122 can be the entire health record or selected information from the entire health record. As one example, the health record may be a note prepared by one or more caregivers documenting an encounter with the patient during a patient examination. The health record 122 can include the complete patient note, or may include limited data regarding the note, such as a date, record type, and one or more keywords, for example. In some embodiments the health record 122 further includes a link or other identifier of the health record that can be used to access the health record from the health record system 108.

The request 430 is received by the universal health identifier server 106 and processed by the record indexing engine 200. In some embodiments the record indexing engine 200 retrieves the universal health identifier 366 from the request and uses the universal health identifier 366 to locate the respective patient's record 116. The health record 122 is then processed and some or all of the information contained therein is stored in the patient's record 116. In some embodiments the record indexing engine 200 includes a translation engine that converts the health record 122 from a variety of possible incoming formats into a native format that is used in the patient record 116.

In some embodiments the record indexing engine 200 generates a universal record identifier 434 for the record, and stores the universal record identifier 434 in the patient record and associated with the health record 122 contained therein. The universal record identifier can be generated using a hash function or as a universally unique identifier, for example, both of which are discussed in further detail herein.

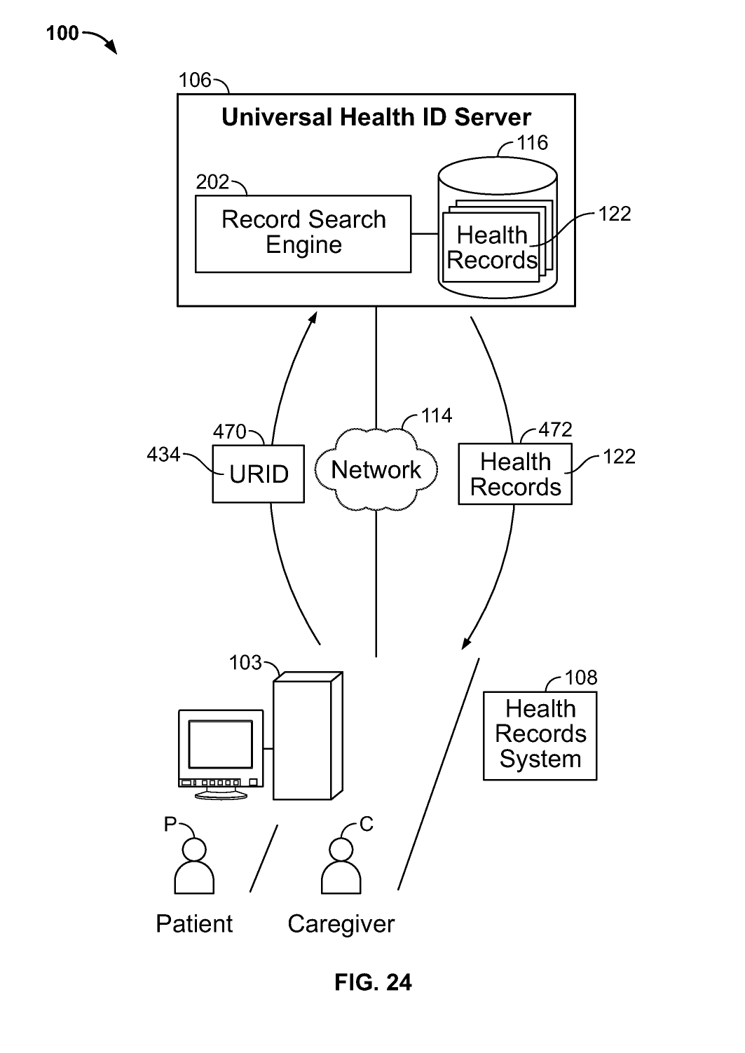

In some embodiments the record indexing engine 200 generates a response 432 that is sent back to the requesting system that indicates whether or not the indexing was successful. In some embodiments, if the indexing was successful, the response includes the universal record identifier 434, which can be subsequently used by the requesting system or the user to identify and access the health record 122, such as shown in FIG. 24.

FIG. 21 illustrates an example of a health record 122. In this example, the health record 122 includes or is associated with a universal record identifier 434, a universal health identifier 366 of the patient, a source identifier 442, a location 444, and an excerpt 446. The health record 122 can be stored in the patient's record 116, as shown in FIG. 20, for example.

The health record 122 includes the universal record identifier 434 that can be used to uniquely identify the health record.

The health record 122 is associated with the patient, in some embodiments, by the patient's universal health identifier 366.

Some embodiments identify a source of the record, and include a source identifier 442. The source can be a name of the source that generated and/or provided the record (such as any of the systems shown in FIG. 20), or a link to the source, such as a URL to a login page, for example.

The location 444 of the health record 110 (FIG. 1) is included in some embodiments to link to the original source or the current storage location of the health record 110. In some embodiments the location is a link, such as a URL, to the health record 110, for example. In another example, the location includes a record identifier that can be used to locate the record at the source, such as by logging into the source (identified by the source identifier 442), and retrieving the record using the record identifier.

Some embodiments include an excerpt 446 from the health record, or keywords. The excerpt and keywords can be used for search and filtering functions, or simply to provide the user with brief information about the health record so that the user can determine whether the health record is of interest for a particular inquiry.

The health record 122 is only one example of a possible health record, and other embodiments can include more, less, or different information than the example shown in FIG. 21.

FIGS. 22-24 illustrate examples of the record search engine 202, of the example universal health identifier server 106, shown in FIG. 3.

FIG. 22 is a schematic block diagram illustrating another example of a portion of the patient identification system 100, shown in FIG. 1. More particularly, FIG. 22 illustrates a record search and retrieval functions performed by some embodiments of the universal health identifier server 106. In this example, the patient identification system 100 includes the user computing device 103, the universal health identifier server 106 including the record search engine 202 and patient record 116, which communicate across the data communication network 114. Also shown are a request 430, a response 432, a universal health identifier 366, a health record 122, and a universal record identifier 434.

In some embodiments the universal health identifier server 106 includes the record search engine 202 that can receive search requests 450 from users, conduct a search of the patient records 116 to identify health records 122 that satisfy the search request, and provide search results 452 in response.

In this example, the user computing device 103 prompts the user (e.g., the patient P or caregiver C) to define a search query. The search query can include one or more parameters that are to be searched. Examples of such parameters include an identification of a patient (e.g., a patient identifier, patient identifier hash, or a universal health identifier), a keyword, a subject or type of health record, a date or date range, a source of the health record, or any other parameters associated with data stored in the patient record 116.

Once the search query has been defined, the user computing device 103 generates a search request 450. In this example the search request 450 includes the universal health identifier 366 of the patient P.

One example of the search request is formatted as follows: www.example.com/[uhid]/authorization_token?search=“diabetic retinopathy screening,” where “[uhid]” is the universal health identifier for a patient, and “diabetic retinopathy screening” is the search query.”

The search request is received by the universal health identifier server 106 and is processed by the record search engine 202. The patient records 116 are then searched by the record search engine 202 to identify any health records 122 that satisfy the query. In some embodiments the record search engine 202 determines that a health record satisfies the search query by determining whether the health record matches the parameters in the search request 450. In other embodiments, the record search engine 202 ranks the health records in order of relevance, and a predetermined number of the highest ranked health records are returned, for example.

The search results 452 response is generated and send from the record search engine 202 to the user computing device 103, including the health records 122A,B that satisfied the query.

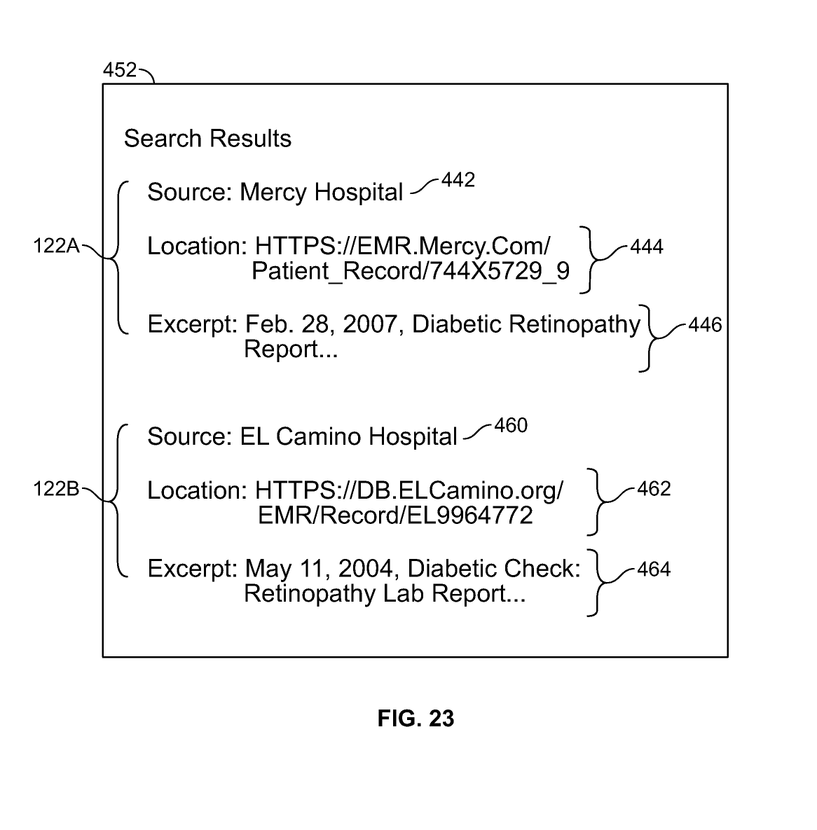

FIG. 23 illustrates an example of the search results 452 response. In this example, the search results 452 identify health record 122A and health record 122B. Data from each health record 122A,B is also provided, such as the source 442 and 460, the location 444 and 462, and an excerpt 446 and 464. The search results can then be formatted and displayed to the user in any desired format. Further, in some embodiments the health record 122A,B includes a link to the original or current storage location for the health record in the location 444 or 462, such as a link to the health records system 108 (FIG. 1), which can be selected to navigate to and access the health record including additional information or health data than may be stored in the patient record 116. In some embodiments the patient or caregiver must first login to the health record system 108 (and accordingly, must have access to same) before the information can be viewed. In this way the existing security measures provided by the health record systems 108 can be utilized to safeguard the patient's sensitive and confidential health information.

FIG. 24 is a schematic block diagram illustrating another example of a portion of the patient identification system 100, shown in FIG. 1. More particularly, FIG. 24 illustrates another record search and retrieval function performed by some embodiments of the universal health identifier server 106. In this example, the patient identification system 100 includes the user computing device 103, the health records system 108, the universal health identifier server 106 including the record search engine 202 and patient record 116, which communicate across network 114. Also shown are a request 470, a response 472, the universal record identifier 434, and the health record 122.

In some embodiments the health records stored in the patient record 116 are associated with a universal record identifier 434 to uniquely identify each record. The universal record identifier 434 can therefore be used to request that record.

In this example, a request 470 is generated by a user computing device 103 or a health records system 108. The request 470 includes the universal record identifier 434 associated with a particular health record 122A.

One example of the request 470 is a GET API formatted as follows: www.example.com/[uhid]/[urid]/authorization_token?output_format=pdf, where “[uhid]” is the universal health identifier of the patient, “[urid]” is the universal record identifier for the desired record, and pdf is the desired output file format. In some embodiments the request 470 can also include a request to forward a record to another location, such as to a particular patient record in an electronic medical record system. The output format designation triggers a translation function of the universal health identifier server, which will translate the record into a variety of different forms so that the health record 472 is provided in a format usable by the recipient system or person.

The request is received by the universal health identifier server 106, and is processed by the record search engine 202. The record search engine 202 retrieves the universal record identifier 434 from the request and uses it to retrieve the health record 122 from the patient record 116.

The record search engine 202 then generates a response 472 that includes the health record 122, which is provided to the system that submitted the request 470.

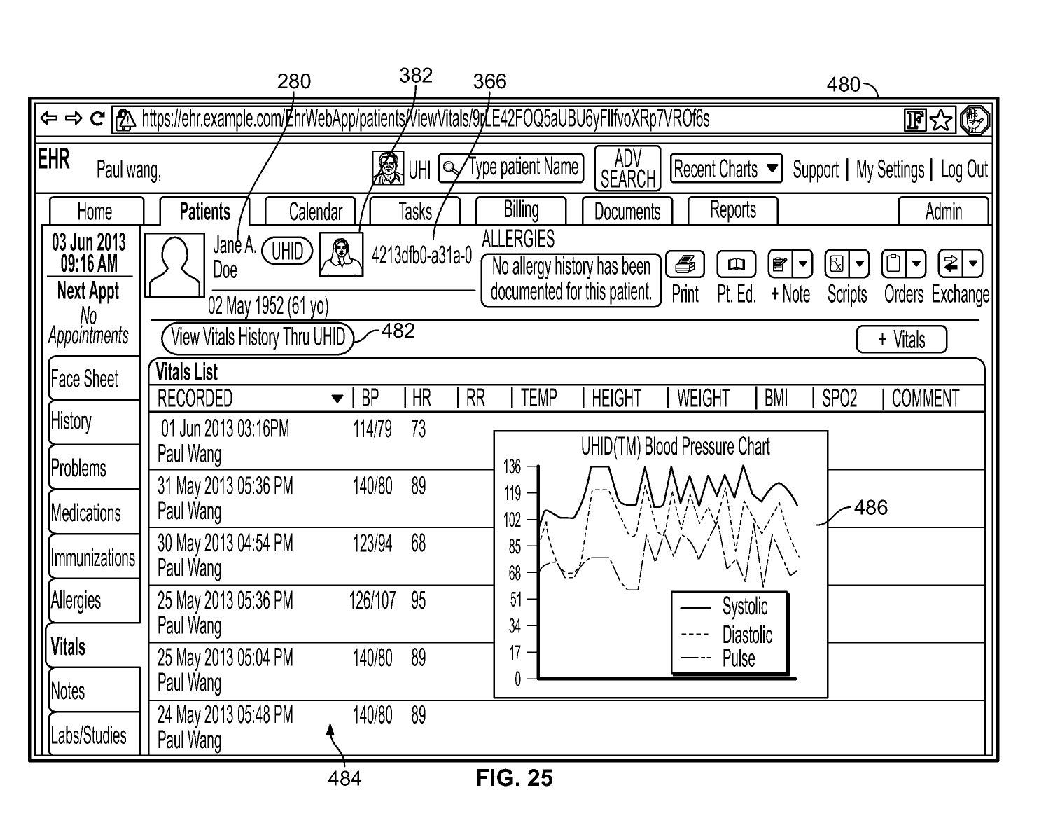

FIG. 25 is a screen shot of an example electronic health record system implementing aspects of the present disclosure. More specifically, FIG. 25 is a screen shot illustrating an example user interface of the electronic health records system.

In this example, the electronic health record system includes a selectable view vitals control 482, which can be selected to initiate a process to view vitals history using the universal health identifier. Upon selection of the view vitals control 482, the electronic health records system submits a search request 450 (FIG. 22) to the universal health identifier server 106 to request health records of the patient that contain past vitals data. More specifically, the search request includes the universal health identifier 366 and a search parameter for health records having a record type of “vitals.”

A search results 452 response is received that includes the health records of the patient that include vitals data. The electronic health record system then updates the user interface 480 to display a list 484 of health records and the associated vitals data. As another example, the data is plotted in a graphical form 486.

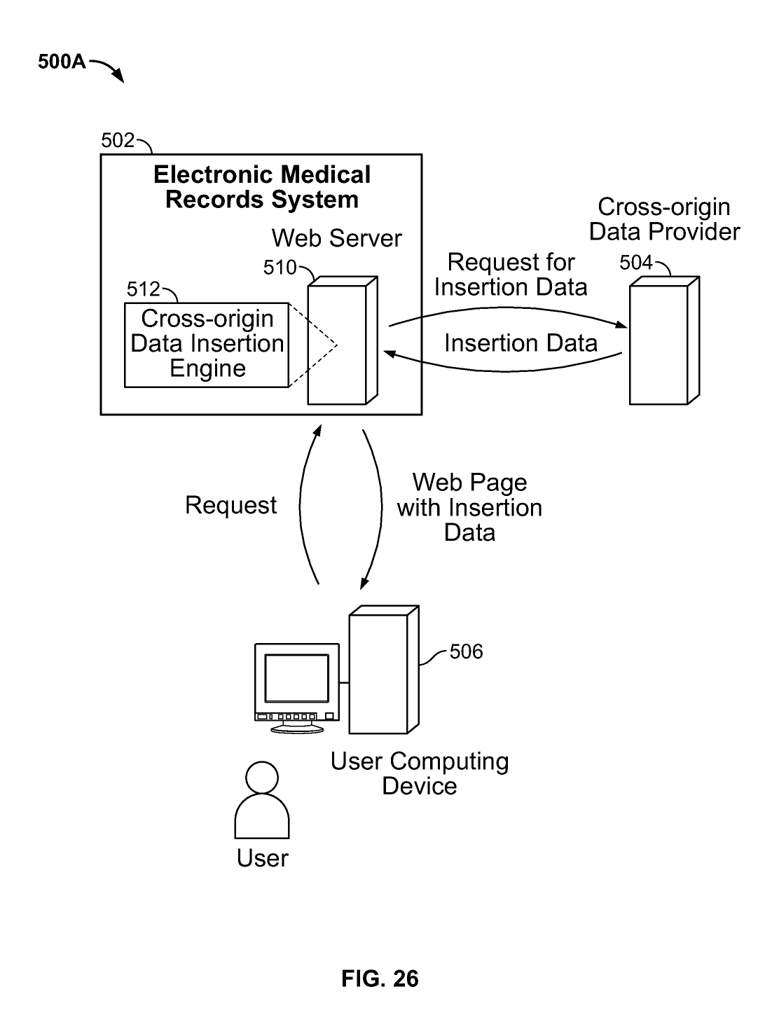

FIG. 26 is a schematic block diagram illustrating an example of a cross-origin data presentation system 500A. In this example, the cross-origin data presentation system 500A includes an electronic medical records system 502, a cross-origin data provider 504, and a user computing device 506. In some embodiments the cross-origin data provider 504 is the universal health ID server 106, discussed herein.

In some embodiments, the cross-origin data presentation system 500A operates to present information to the user at a user computing device where the data originates from multiple different sources. For example, some of the data comes from the electronic medical records system 502, and other data comes from one or more cross-origin data providers 504. The information is combined into a single presentation that is displayed to the user at the user computing device 506.

It would often be desirable to obtain data from multiple different sources and to present that information through a unified display. For example, an electronic medical records system containing patient data can be used to display information including the patient data to the user. Other data may be available from other sources, such as data collected by a medical device that is associated with the same patient. In order to display the medical device data through the electronic medical records system, it would typically be required to provide a data connection between the two, transform and translate that data between different data formats, and then customize data display formats. This process may need to be repeated with each unique device and data set. Therefore, it is not a simple matter to retrieve and display data from another source.

In this example, the electronic medical records system 502 includes a web server 510 that includes a cross-origin data insertion engine 512. The cross-origin data insertion engine 512 operates to retrieve the desired data from one or more cross-origin data providers 504, and then to insert that data directly into predefined locations on a web page, without requiring the data to be imported into or even understood by the electronic medical records system 502. Whatever data is retrieved, can simply be displayed on the web page. This process bypasses the backend processing that may otherwise be required, and provides a frontend solution that overcomes the drawbacks and difficulties that would otherwise be encountered.

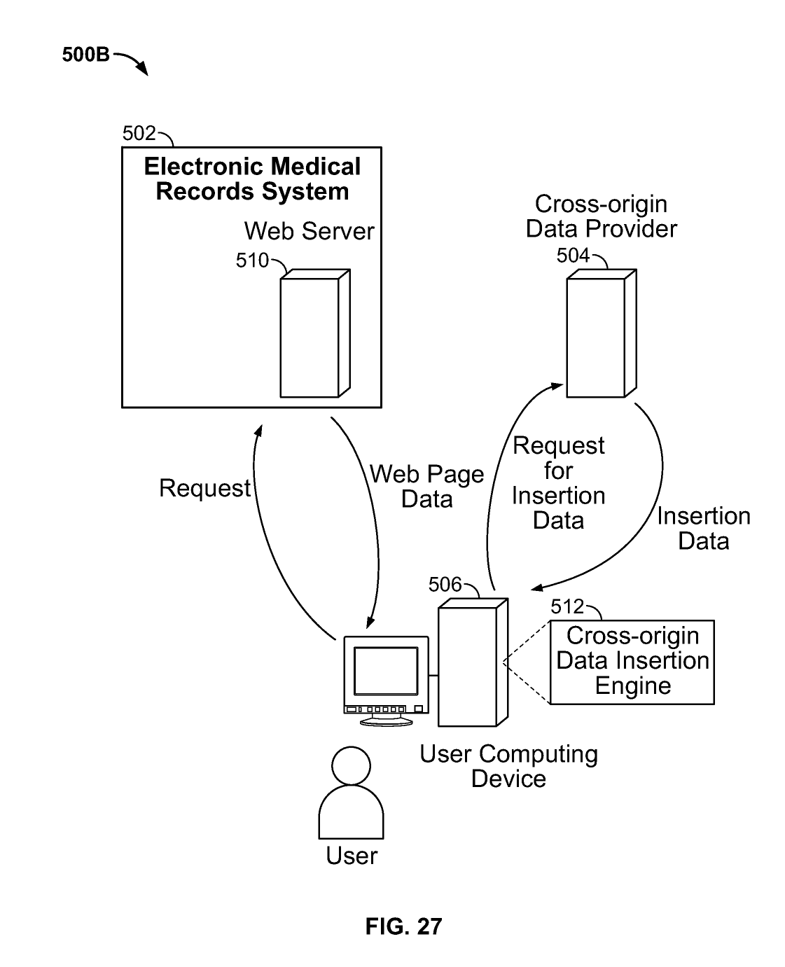

One example of the cross-origin data presentation system 500A will now be described with reference to FIG. 26, with further examples and details of example embodiments being subsequently discussed with reference to FIGS. 27-31.

The user computing device 506 connects with the web server 510 of the electronic medical records system, which may involve navigating to a login page where the user enters login credentials. Once logged in, the user navigates through the web site and makes selections that cause navigation to additional web sites.

When the user wishes to view a particular web page, such as to review an electronic medical record for a particular patient, a request is submitted from the user computing device 506 to the web server 510 that requests that the web server 510 provide the web page data.

The web server 510 receives the request and generates or retrieves the appropriate web page data. Before sending the web page data to the user computing device 506, the web server 512 calls the cross-origin data insertion engine 512 to determine whether any additional data should be displayed in the web page.

If the cross-origin data insertion engine 512 determines that additional data should be displayed, the web server 510 generates and sends a request for insertion data to the cross-origin data provider that has that data. The cross-origin data provider 504 responds with the requested insertion data.

Once the insertion data has been received, the web page data is sent to the user computing device 506 with the insertion data included therein. The web page and the insertion data are then presented to the user, such as by displaying the web page on a display device.

FIG. 27 illustrates another example of a cross-origin data presentation system 500B. Like the example shown in FIG. 26, the cross-origin data presentation system 500B also includes an electronic medical records system 502, a cross-origin data provider 504, and a user computing device 506. The electronic medical records system 502 includes a web server 510. In this example, the cross-origin data insertion engine 512 operates on the user computing device 506.

In this example, a request for a web page is sent from the user computing device 506 to the web server 510.

The web server 510 responds with the web page data.

Before displaying the web page, the cross-origin data insertion engine 512 processes the web page data and determines whether additional data should be displayed. If so, a request for insertion data is sent to one or more cross-origin data providers 504, which responds with the requested insertion data.

The cross-origin data insertion engine then inserts the insertion data into the web page, which is then displayed to the user by the user computing device 506.

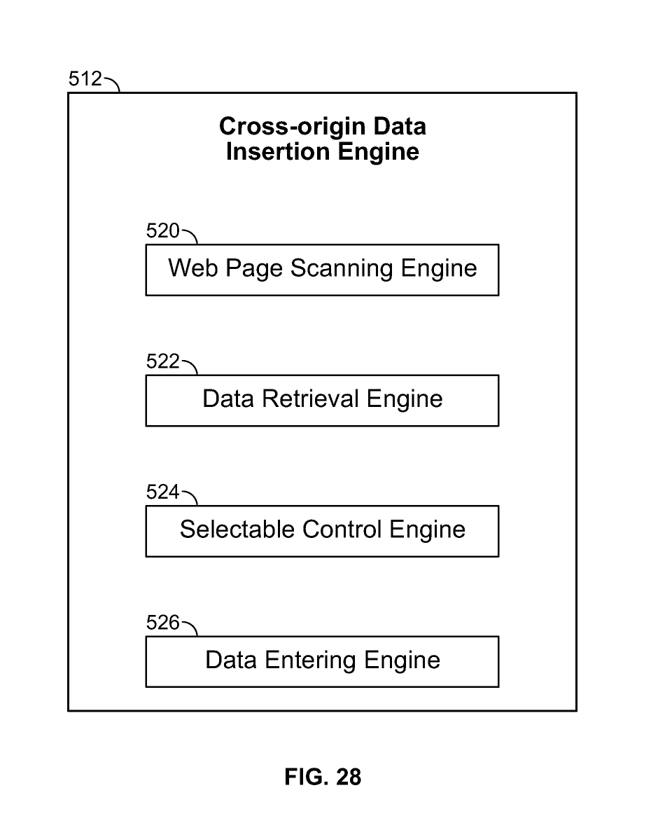

FIG. 28 is a schematic block diagram illustrating an example of the cross-origin data insertion engine 512. In this example the cross-origin data insertion engine includes a web page scanning engine 520, a data retrieval engine 522, and a selectable control engine 524.

In the example data presentation system 500B, shown in FIG. 27, the cross-origin data insertion engine operates on the user computing device 506. In some embodiments, the execution of the cross-origin data insertion engine is initiated by a browser software application, such as by the Google™ Chrome™ browser software application. More specifically, in some embodiments the cross-origin data insertion engine 512 is a browser extension, such as a Chrome extension, which provides a mechanism for a javascript injection (contentscript) before a web page is loaded and displayed by the browser software application.

Before loading the web page, the cross-origin data insertion engine 512 utilizes the web page scanning engine 520 to scan the web page data and determine whether the web page is a page of interest. In some embodiments the determination of whether the web page is a page of interest is based on whether or not the web page is of a particular type, such as a web page from a records provider (e.g., an electronic medical records system, an electronic health records system, a personal health records system, or the like). In some embodiments the decision is made based on the URL of the web page, such as by comparing the URL with a list of records provider URLs.

If determined that the web page is a page of interest, the web page scanning engine 520 then scans the page for content of interest. If content of interest is found, the cross-origin data insertion engine 512 utilizes one or more of the data retrieval engine 522 and the selectable control engine 524 to obtain insertion data from a cross-origin data provider 504 (FIGS. 26-27). One example of context of interest is a patient's name, which can be identified in the web page by searching for a css id, such as #patient_name, within the web page. The web page scanning engine 520 can search the page for any other content or context of the web page. For example, the web page scanning engine 520 can search for any one or more of keywords, URL, title, tags, css classes, css ids, html body, etc. to determine whether the web page is of interest, and/or to identify content of interest in or associated with the web page. In some embodiments one or more rules are defined that can be used to determine whether or not a web page is of interest, whether the web page contains content of interest, and what to do if certain content of interest is identified. For example, the content can trigger the operation of one or more of the data retrieval engine 522 and the selectable control engine 524.

In some embodiments the data retrieval engine 522 operates to request and retrieve insertion data from one or more cross-origin data providers 504, such as shown in FIGS. 25 and 26. More specifically, the cross-origin data provider 504 generates a request for insertion data based on the content of interest found in the web page, and sends the request to the cross-origin data provider 504. One example of the cross-origin data provider 504 is a universal health ID server 106 as discussed throughout this paper. For example, the request can include a request for a universal health identifier based on a patient identifier found in the web page, such as the patient's name. In some embodiments the cross-origin data insertion engine converts the patients name to a patient hashing identifier, as discussed herein, before sending the request.

The cross-origin data provider 504 receives the request and retrieves from a data storage device the requested data. As one example, the universal health identifier server 106 uses the patient hashing identifier to retrieve the patient's universal health identifier, and sends the universal health ID back to the requesting web server 510 as insertion data.

The cross-origin data insertion engine 512 then processes the web page data to include the insertion data, which is then displayed on the user computing device to the user.

Several examples of data that can be retrieved by the data retrieval engine 524 include the universal health identifier, a photograph (such as the patient's gravatar), patient health data (including medical device data, laboratory data, medical record data, graphical representations of such data, or other health-related data of a patient).

The selectable control engine 524 operates to generate one or more selectable controls that can be inserted into the web page as insertion data. Examples of selectable controls include a button and a link. Once displayed, the user can select the selectable controls in the web page to initiate an action, such as to navigate to another web page, or to send data or commands to the cross-origin data source 512 or another computing device.

The data entering engine 526 operates to define a data entry element in a web page. Examples of a data entry element include any of a variety of web page input elements, such as a text box. Once displayed, the user can enter information into the data entry element, which is then sent to the cross-origin data provider 504, or another computing device.

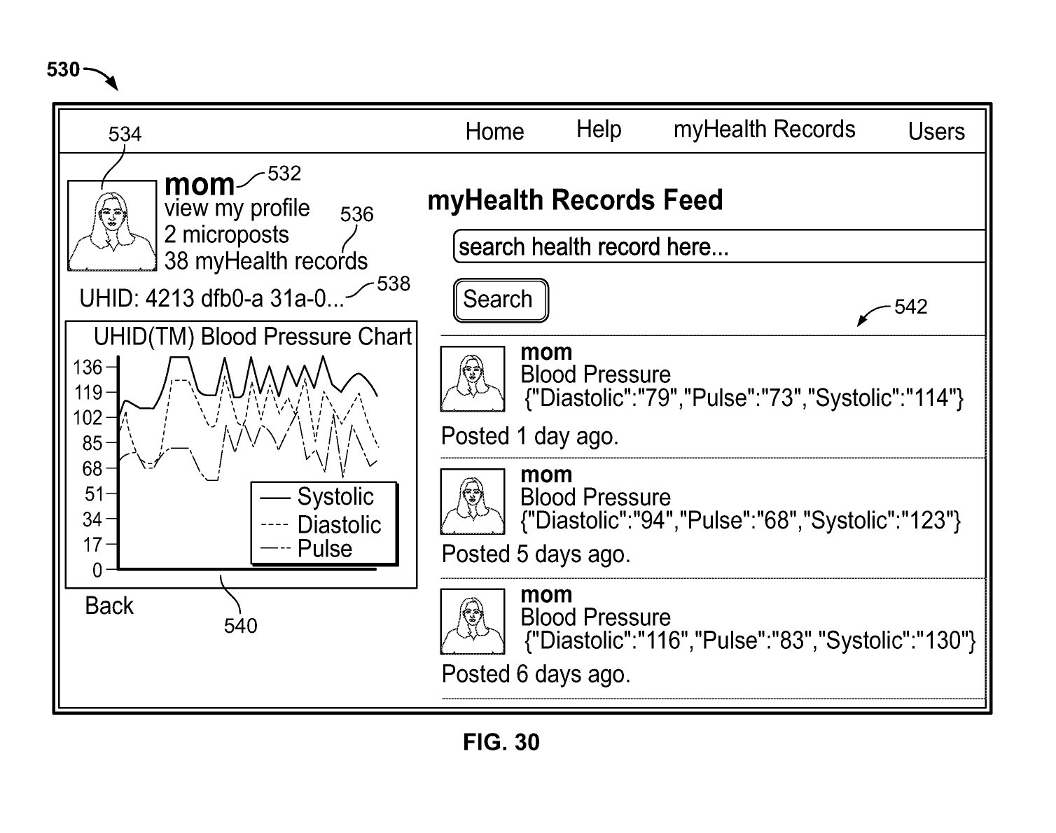

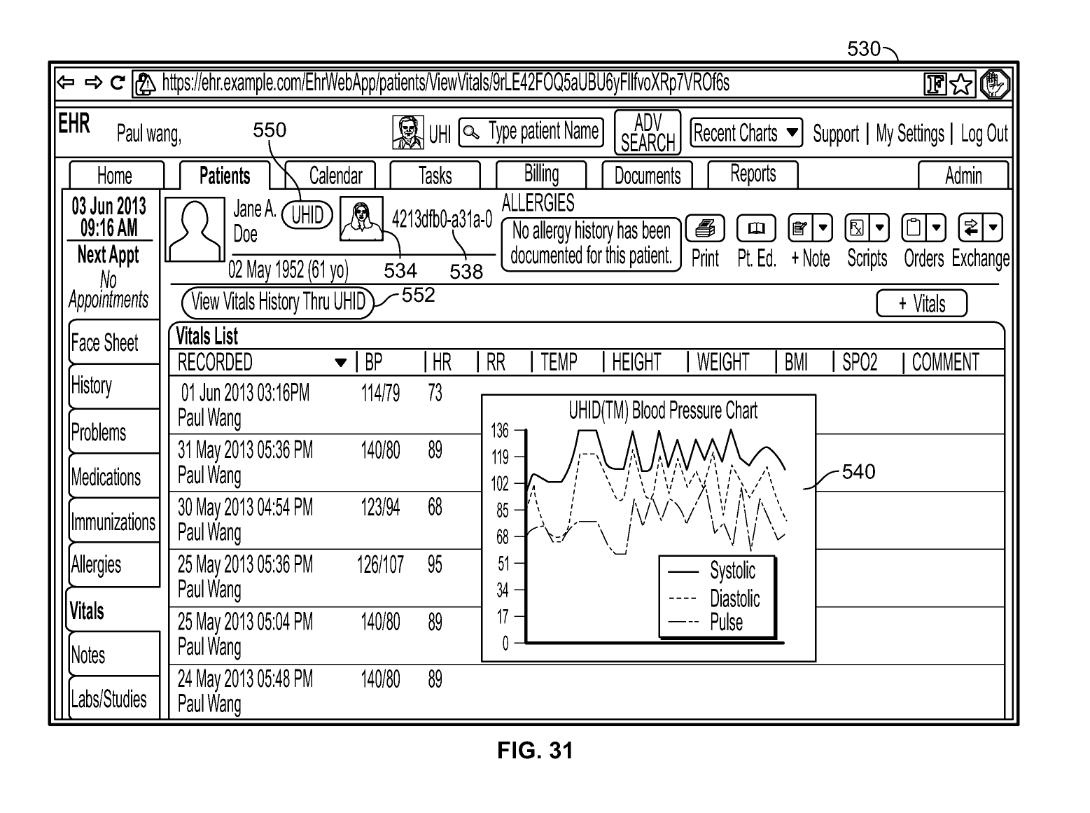

Several examples of the data retrieval engine 524 and the selectable control engine 524 are illustrated and described in more detail with reference to FIGS. 30-31 herein.

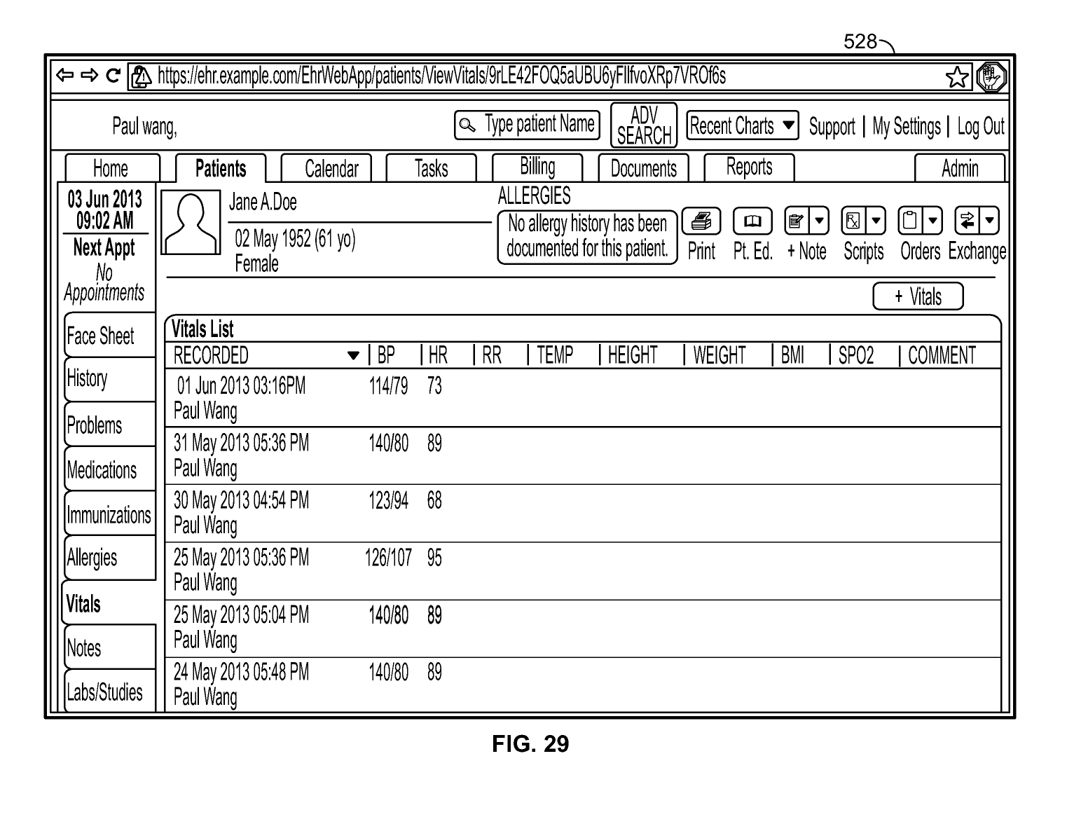

FIG. 29 illustrates an example of a web page 528 provided by the web server 510 (FIGS. 25 and 26) prior to the addition of insertion data by the cross-origin data insertion engine 512. In this example, the web page 528 is a display of the electronic medical records system 502, displaying an electronic medical record of a patient (with patient name “Jane A. Doe”).

FIG. 30 is a graphical representation of the data 530 stored by the cross-origin data provider 504, and available for display in the web page 528. In this example, the cross-origin data provider 504 data 530 includes a patient identifier 532, (“mom”), a photograph 534, a number of posts and records available 536, the patient's universal health identifier 538, a graphical representation of health data 540 (such as a blood pressure chart), and vitals history data 542.

FIG. 31 is a screen shot of the example web page 528 as displayed to the user by the user computing device 506, after the addition of insertion data to the web page 528 from the cross-origin data provider 504.

In this example, the web page 528 includes data and selectable controls provided by the cross-origin data provider 504. The data includes the photograph 534, the universal health identifier 538, and the graphical representation of health data 540. The selectable controls include the UHID button 550 and the View Vitals History Thru UHID button 552.

As discussed herein, some embodiments of the cross-origin data provider 504 utilize code as a browser extension to retrieve and dynamically insert data into the web page. Several examples of such code are discussed below.

Code example 1 operates to insert a UHID button 550 next to the patient's name. In some embodiments the code example 1 is a jQuery command in the contentscript.

### Code Example 1

$(‘#patient-name’).append(“<a href=‘#’ id=‘clickingEvent1’
class=‘myButton’>UHID </a>”);

Code example 2 operates to retrieve a universal health identifier 538 and a photograph 534. If the patient is not signed up with the universal health ID server, a UHID signup button is displayed to invite the patient to signup. If selected, the UHID signup button causes the user computing device to navigate to a registration page provided by the universal health identifier server.

### Code Example 2

//onclick “UHID” button to retrieve patient's UHID
$(‘a.myButton’).click(function( ) {
//try to retrieve uhid from local storage if it exists
chrome.extension.sendRequest({method: “getUHID”},
function(response) {
uhid = response.data;
});
chrome.extension.sendRequest({method: “getPatientAvatar”},
function(response) {
patient_avatar = response.data;
});
if(uhid == “”){
$.get(url, function(data) {
var display = “”;
display = $.parseJSON(JSON.stringify(data)).UHID;
if (display === undefined){
display = $.parseJSON(JSON.stringify(data)).Error;
//show “Signup UHID” button
UHID_iframe_button(‘#vital-history-actions’,‘Signup for
UHID’,‘myButton’);
}
$(‘#patient-name’).append(display);
});
} else {
$(‘#patient-name’).append(“<img src=“‘+patient_avatar+”?s=52’/>”);
$(‘#patient-name’).append(“&amp;nbsp;&amp;nbsp;”+uhid);
}
return false; // prevent default
});

If the contentscript determines that there are data fields to be entered, such as a blood pressure reading, the code example 3 can be used to fill in that information in the web page. Determining whether data fields are present and need to be entered can be accomplished by searching the web page for css ide names: #vital_measurement_bp_in_systolic, #vital_measurement_bp_in_diastolic, #vital_measurement_heart_rate, etc., for example. The following javascript code will automatically fill these field in with appropriate remote BP readings recorded by UHID platform services.

### Code Example 3

function Fill_vitals_data( )
{
//get vitals record from UHID
var myhealth_url = ‘https://uhid.heroku.com/myhealth/’+
uhid_remember_token + ‘/’ +
uhid + ‘.json’;
$.get(myhealth_url, function(data) {
var myhealths = $.parseJSON(JSON.stringify(data));
var last_content = $.parseJSON(myhealths[1].content);
$(‘#vital_measurement_bp_in_systolic’).val(last_content.Systolic);
$(‘#vital_measurement_bp_in_diastolic’).val(last_content.Diastolic);
$(‘#vital_measurement_heart_rate’).val(last_content.Pulse);
});
}

The code example 4 generates a button that provides a link to a cross-origin web site (e.g., a web site provided by a server other than the web server 510).

### Code Example 4

function UHID_iframe_button(selector,button_name,button_style)
{
var flink = “&amp;nbsp;<a class=‘various fancybox.iframe “+button_style+”’
href=‘https://uhid.heroku.com’>“+button_name+”</a>”;
$(selector).append(flink);
$(“.various”).fancybox({
‘width’:1000,
‘height’:400,
‘type’:‘iframe’,
‘autoScale’:‘false’
});
}

Some embodiments include one or more of the following, and combinations thereof:

A method for registering and issuing a universal health identifier associated with a patient over a communication network, the method comprising: receiving with a computing device a patient identifier associated with a patient; generating a patient hashing identifier using the patient identifier; generating a universal health identifier; and associating the universal health identifier to the patient identifier.

A method wherein the patient identifier is a human-friendly code, selected from an e-mail address, a telephone number, an address, a government identification code, and a health care provider identification number.

A method wherein the generating the patient hashing identifier comprises applying a hash function to the patient identifier.

A method wherein the patient hashing identifier is a 128-bit code.

A method wherein the hash function is selected from a SHA-1 hash function, an SHA-2 hash function, and an MD5 hash function.

A method wherein generating a universal health identifier comprises generating a universally unique identifier and assigning the universally unique identifier as the universal health identifier.

A method wherein associating the universal health identifier to the unique patient identifier comprises associating in a database.

A method further comprising validating the patient identifier.

A method wherein validating the patient identifier comprises communicating with one of: a social network system, a globally recognized avatar system, an electronic medical records system, and a driver's license database.

A method further comprising: receiving a second patient identifier associated with the patient; generating a second patient hashing identifier using the second patient identifier; and associating the universal health identifier with the second patient identifier.

A method of distributing a universal health identifier across a data communication network, the method comprising: receiving a request using a computing device, the request including a patient hashing identifier, the patient hashing identifier being a code generated by applying a hashing function to a patient identifier; retrieving a universal health identifier associated to the patient hashing identifier; and sending a response to the request, the response including the universal health identifier.

A method wherein receiving the request comprises receiving the request by a web service using a RESTful application programming interface.

A method wherein the universal health identifier is a universally unique identifier.

A method of providing access to medical records, the method comprising: receiving, using a computing device, a universal health identifier associated with a patient from a data communication network; using the universal health identifier to retrieve a link to a medical record associated with the patient from a repository; and sending the link to the medical record through the data communication network.

A method further comprising using a single-sign-on service to validate the association between the universal health identifier and the patient.

A method wherein the medical record is stored remote from the repository.

A method wherein the medical record is stored in a medical record system provided by a first record provider.

A method further comprising: using the universal health identifier to retrieve a link to a second medical record associated with the patient from the repository; and sending the link to the second medical record through the data communication network, wherein the second medical record is stored in a medical record system provided by a second record provider different than the first record provider.

A method further comprising generating a list of medical records associated with the patient from the repository including links to the respective medical records; and sending the list across the data communication network.

A method further comprising: receiving a search query specifying one or more search parameters; searching the repository for medical records associated with the universal health identifier that satisfy the one or more search parameters; and sending a list of the medical records that satisfy the one or more search parameters, the list including for each medical record a link to the medical record.

A method wherein the list of the medical records is sent to an electronic medical records system, and wherein the electronic medical records system displays the list on an electronic medical records page.

A method wherein the medical records listed in the list are selectable, wherein upon selection of the medical record from the list, data associated with the medical record is displayed by the electronic medical records system.

A method for registering and issuing a universal health identifier associated with a patient over a communication network, the method comprising: receiving with a computing device a patient demographics record; attempting to match the patient demographics record with existing patient records, and when a match is not found: generating a patient hashing identifier using the patient identifier; generating a universal health identifier; and associating the universal health identifier to the patient identifier.

A method wherein the patient identifier is a human-friendly code, selected from an e-mail address, a telephone number, an address, a government identification code, and a health care provider identification number.

A method wherein the generating the patient hashing identifier comprises applying a hash function to the patient identifier.

A method further comprising: receiving a second patient identifier associated with the patient; generating a second patient hashing identifier using the second patient identifier; and associating the universal health identifier with the second patient identifier.

A method of distributing a universal health identifier across a data communication network, the method comprising: receiving a request using a computing device, the request including a patient demographics record; matching with existing patient records and when a match is found: retrieving a universal health identifier associated to the patient demographics record; and sending a response to the request, the response including the universal health identifier.

A method wherein receiving the request comprises receiving the request by a web service using a RESTful application programming interface.

A method of providing access to medical records, the method comprising: receiving, using a computing device, a patient demographics record associated with a patient from a data communication network; using a universal health identifier associated to the patient demographics record to retrieve a link to a medical record associated with the patient from a repository; and sending the link to the medical record through the data communication network.

A method further comprising using a single-sign-on service to validate the association between the universal health identifier and the patient.

A method wherein the medical record is stored remote from the repository.

A method wherein the medical record is stored in a medical record system provided by a first record provider.

A method further comprising: using the universal health identifier to retrieve a link to a second medical record associated with the patient from the repository; and sending the link to the second medical record through the data communication network, wherein the second medical record is stored in a medical record system provided by a second record provider different than the first record provider.

A method further comprising generating a list medical records associated with the patient from the repository including links to the respective medical records; and sending the list across the data communication network.

A method further comprising: receiving a search query specifying one or more search parameters; searching the repository for medical records associated with the universal health identifier that satisfy the one or more search parameters; and sending a list of the medical records that satisfy the one or more search parameters, the list including for each medical record a link to the medical record.

A method wherein the list of the medical records is sent to an electronic medical records system, and wherein the electronic medical records system displays the list on an electronic medical records page.

A method wherein the medical records listed in the list are selectable, wherein upon selection of the medical record from the list, data associated with the medical record is displayed by the electronic medical records system.

A method of presenting health-related information on a web page, the method comprising: searching web page data for content of interest using a computing device and identifying content of interest, the web page data being generated by a web server; sending a request for insertion data to a cross-origin data provider based on the identified content of interest, wherein the cross-origin data provider is separate from the web server; receiving insertion data; and adding the insertion data to the web page data prior to a display of the web page.

A method wherein the method is performed by the user computing device as a browser extension.

A computing device comprising: a processing device; a network communication device; and a computer readable storage device, the computer readable storage device storing data instructions that when executed by the processing device causes the processing device to execute a cross-origin data insertion engine to: receive web page data for a web page from a web server through the network communication device; determine that the web page is a page of interest; scan the web page to identify content of interest; generate and send a request for insertion data to a remote computing device separate from the web server, based on the identified content of interest; receive the insertion data from the remote computing device; and add the insertion data to the web page data prior to a display of the web page by the computing device.

A computing device wherein determine that the web page is a page of interest comprises determining a type of the web page.

A computing device wherein determining a type of the web page comprises comparing at least a portion of a URL of the web page with a list of web page URLs of interest.

A computing device wherein identifying content of interest comprises searching for one or more predetermined css ids.

A computing device wherein the remote computing device is a universal health ID server computing device.

A computing device wherein adding the insertion data is accomplished using a contentscript javascript insertion as a browser extension.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A method for registering and issuing a universal health identifier associated with a patient over a communication network, the method comprising:
receiving with a computing device a patient identifier associated with a patient;
generating a patient hashing identifier using the patient identifier;
generating a universal health identifier; and
associating the universal health identifier to the patient identifier.

2. The method of claim 1, wherein the patient identifier is a human-friendly code, selected from an e-mail address, a telephone number, an address, a government identification code, and a health care provider identification number.

3. The method of claim 1, wherein the generating the patient hashing identifier comprises applying a hash function to the patient identifier.

4. The method of claim 3, wherein the patient hashing identifier is a 128-bit code.

5. The method of claim 4, wherein the hash function is selected from a SHA-1 hash function, an SHA-2 hash function, and an MD5 hash function.

6. The method of claim 1, wherein generating a universal health identifier comprises generating a universally unique identifier and assigning the universally unique identifier as the universal health identifier.

7. The method of claim 1, wherein associating the universal health identifier to the unique patient identifier comprises associating in a database.

8. The method of claim 1, further comprising validating the patient identifier.

9. The method of claim 6, wherein validating the patient identifier comprises communicating with one of: a social network system, a globally recognized avatar system, an electronic medical records system, and a driver's license database.

10. The method of claim 1, further comprising:
receiving a second patient identifier associated with the patient;
generating a second patient hashing identifier using the second patient identifier; and
associating the universal health identifier with the second patient identifier.

11. A method of distributing a universal health identifier across a data communication network, the method comprising:
receiving a request using a computing device, the request including a patient hashing identifier, the patient hashing identifier being a code generated by applying a hashing function to a patient identifier;
retrieving a universal health identifier associated to the patient hashing identifier; and
sending a response to the request, the response including the universal health identifier.

12. The method of claim 11, wherein receiving the request comprises receiving the request by a web service using a RESTful application programming interface.

13. The method of claim 11, wherein the universal health identifier is a universally unique identifier.

14. A method of providing access to medical records, the method comprising:
receiving, using a computing device, a universal health identifier associated with a patient from a data communication network;
using the universal health identifier to retrieve a link to a medical record associated with the patient from a repository; and
sending the link to the medical record through the data communication network.

15. The method of claim 14, further comprising using a single-sign-on service to validate the association between the universal health identifier and the patient.

16. The method of claim 14, wherein the medical record is stored remote from the repository.

17. The method of claim 14, wherein the medical record is stored in a medical record system provided by a first record provider.

18. The method of claim 14, further comprising:
using the universal health identifier to retrieve a link to a second medical record associated with the patient from the repository; and
sending the link to the second medical record through the data communication network, wherein the second medical record is stored in a medical record system provided by a second record provider different than the first record provider.

19. The method of claim 14, further comprising generating a list of medical records associated with the patient from the repository including links to the respective medical records; and sending the list across the data communication network.

20. The method of claim 14, further comprising:
receiving a search query specifying one or more search parameters;
searching the repository for medical records associated with the universal health identifier that satisfy the one or more search parameters; and
sending a list of the medical records that satisfy the one or more search parameters, the list including for each medical record a link to the medical record.

21-55. (canceled)
